(19) United States
(12) Patent Application Publication
(10) Pub. No.: US 2026/0339406 A1
(43) Pub. Date: Oct. 29, 2026

(54) SYSTEMS AND METHODS OF IMPROVING ENERGY EFFICIENCY AND THERMAL CONTROL FOR LARGE ELECTRIC LOAD

(71) Applicant: Axiado Corporation, San Jose, CA (US)

(72) Inventors: Raghu Kondapalli, San Jose, CA (US); Zhichao Zhang, Livermore, CA (US); Sidhartha Adatrao, Redwood City, CA (US)

(21) Appl. No.: 19/657,502

(22) Filed: Apr. 24, 2026

Related U.S. Application Data
(60) Provisional application No. 63/795,992, filed on Apr. 28, 2025.

(51) Int. Cl. G06F 1/20; G05B 13/02

(52) U.S. Cl. CPC G06F 1/206; G05B 13/027

(57) ABSTRACT

Disclosed herein are systems and methods for control and adjustment of a cooling system. The disclosed systems include at least one processor, a memory, and instructions executable by the at least one processor. The disclosed systems can be configured to perform the disclosed methods. The disclosed methods include associating hardware temperature data pertaining to computing unit; determining a workload for the computing unit; generating a cooling plan for the computing unit based at least in part on the associated with hardware temperature data and the determined workload; and communicating with a cooling system to adjust one or more cooling elements of the cooling system based at least in part on the generated cooling plan.

### CROSS-REFERENCE TO RELATED APPLICATIONS

This application claims the benefit of U.S. Provisional Application No. 63/795,992, filed Apr. 28, 2025, which is incorporated by reference herein in its entirety.

### BACKGROUND

Computational infrastructure such as data storage centers may have a large number of power-consuming electronics such as servers. For instance, as AI models grow more complex and their applications become more widespread, data centers have become significant contributors to global carbon emissions and energy consumption. A typical data center housing 100,000 servers consumes massive amounts of electricity and generates substantial emissions. The climate impact is staggering: By some estimates, data centers consume about 2% of global electricity and yet produce as much carbon dioxide as the worldwide airline industry.

### SUMMARY

An effective approach is needed to increase server efficiency and reduce emissions, which will become even more substantial in the coming years. The large number of power-consuming electronics may require cooling to avoid functionality issues caused by overheating. Cooling systems can be used to cool at least a portion of the large number of power-consuming electronics, and sometimes can be used to cool the entirety of the large number of power-consuming electronics, for example by cooling the environment in which these electronics are contained. Although fans are essential components in a server rack and the entire data center infrastructure, they often are not recognized for their contribution to energy costs and emissions. Cooling systems, including fans, typically account for between 30% and 40% of a data center's total energy consumption and can consume from 10% to 25% of the total energy used, depending on the data center's specific design and efficiency. Fan systems can sometimes consume several megawatts of power; even a moderately-sized data center might use 500 kW to 1 MW of power.

Traditional cooling systems in data centers face several significant challenges. They are often inefficient, running at constant high speeds and consuming excessive energy regardless of actual cooling needs. The reason for this excessive energy use is that most fan control methods use proportional integral derivative (PID) controllers with minimal (or no) ability to understand the server's thermal variations. As a result, PID controllers cannot adjust or map the fan speed to server workload fluctuations and variations and may not operate fans at the most energy-efficient speed, leading to higher power consumption. Cooling systems for computational infrastructure, such as servers, are often inefficient and function at constant high speeds even at times when such high speeds are unnecessary. These cooling systems often consume excessive and large amounts of energy by statically performing at the highest level of functionality. Excessive energy use by the cooling systems on a large scale can drastically increase the cost of storing large amounts of computational infrastructure, such as servers, in a single area. Excessive energy use by cooling systems of computational infrastructure may also cause unnecessary stress on the power grid system.

The present disclosure provides systems and methods addressing the above issues in the traditional cooling systems. Systems and methods herein improve the cooling efficiency by providing a Dynamic Thermal Management (DTM) system which beneficially allows fans to be controlled in near real-time, increasing and decreasing speed based on real-time, actual operating conditions. In particular, the DTM system may combine deep learning algorithms such as deep reinforcement learning (DRL) and a proprietary trusted control/compute unit (TCU) and achieves improved energy efficiency than traditional fan control methods. The DTM system provides a significant reduction in power consumption and a corresponding decrease in data center emissions.

Unlike conventional thermal control based on closed-loop feedback where delay may occur due to system response time, the present disclosure provides DTM system capable of making proactive cooling adjustments by anticipating cooling needs based on incoming server workloads. This beneficially allows for preemptive adjustments that minimize feedback loop delays and ensure efficient cooling. In particular, the DTM system may employ predictive artificial intelligence (AI) models and deep reinforcement learning technologies to improve the accuracy of the cooling needs prediction. Systems herein may continuously monitor server temperature and workloads in real time, allowing for dynamic adjustment of the cooling system capacity (e.g., fan speeds) to match real-time cooling requirements and reduce unnecessary power consumption.

In some embodiments, the DTM system herein integrates machine learning models in a specialized AI-driven server management chipset and located near the Baseboard Management Controller (BMC) of the chipset, facilitating proactive cooling adjustments. The specialized AI-driven server management chipset may be a Trusted Control/Compute Unit (TCU) with a plurality of programmable AI engines to implement the AI algorithms herein for accelerated calculation. Combining real-time monitoring, dynamic adjustments, predictive AI modeling, and strategic integration, the DTM systems herein offer a comprehensive solution to optimize data center cooling efficiency and sustainability.

It should be noted that though the DTM system is described in the context of controlling fan speeds, the DTM system is flexible and adaptive to any type of cooling system such as fan-based air cooling, liquid cooling, evaporative cooling and the like.

An aspect of the present disclosure provides a system for dynamic thermal management, the system comprising: at least one processor, a memory, and instructions executable by the at least one processor configured to perform operations comprising: (a) receiving real-time data related to one or more hardware components of a computing unit, wherein the real-time data comprises at least CPU data or memory usage indicative of an incoming workload of the computing unit; (b) feeding the real-time data as input to a deep reinforcement learning model, and outputting a command for adjusting an operation parameter of a cooling system for the computing unit.

In some embodiments, the computing unit is a server or a data center comprising a plurality of servers. In some embodiments, the real-time data is collected by a Baseboard Management Controller (BMC) and wherein the BMC is integrated into a chipset. In some embodiments, the chipset is a Trusted Control/Compute Unit (TCU). In some embodiments, the processor is integrated into the TCU.

In some embodiments, the processor comprises one or more programmable artificial intelligence (AI) engines. In some embodiments, the chipset further comprises a secure Network Interface Card (secure-NIC). In some embodiments, the chipset further comprises a hardware Root of Trust (HROT), or a Trusted Platform Module (TPM), or both.

In some embodiments, the real-time data indicative of the incoming workload of the computing unit comprises one or more of: amount of queries, CPU usage, memory usage, disk input and output (disk I/O) operations, network traffic, server performance counters, or request rates, or any combination thereof. In some embodiments, the real-time data further comprises real-time temperature data. In some embodiments, the real-time temperature data comprises real-time data relating to temperature of the one or more hardware components of the computing unit.

In some embodiments, the deep reinforcement learning model is configured to generate a cooling plan based at least in part on the real-time temperature data. In some embodiments, the cooling plan is generated based at least in part on real-time cooling requirements of the one or more hardware components of the computing unit. In some embodiments, the real-time cooling requirements of the one or more hardware components of the computing unit are determined based at least in part on determining a disparity between the real-time temperature data of the one or more hardware components of the computing unit and a predetermined target temperature of the respective one or more hardware components of the computing unit. In some embodiments, determining the real-time cooling requirements of the one or more hardware components of the computing unit further comprises determining a temperature differential associated with the disparity between the real-time temperature data and the predetermined target temperature for each of the one or more hardware components of the computing unit.

In some embodiments, the command for adjusting an operation parameter of a cooling system for the computing unit is output based at least in part on the determined real-time cooling requirements of the one or more hardware components of the computing unit.

In some embodiments, the deep reinforcement learning model is configured to assess functionality of the one or more cooling elements of the cooling system. In some embodiments, the command for adjusting an operation parameter of a cooling system for the computing unit is generated based at least in part on the real-time data indicative of the incoming workload of the computing unit. In some embodiments, the deep reinforcement learning model is configured to predict an incoming workload of the computing unit based at least in part on the real-time data. In some embodiments, the deep reinforcement learning model is further configured to predict an anticipated cooling requirement of the one or more hardware components of the computing unit based at least in part on the predicted incoming workload.

In some embodiments, the deep reinforcement learning model is further configured to generate the cooling plan based at least in part on one or more of: the predicted incoming workload of the computing unit, the assessed functionality of the one or more cooling elements of the cooling system, the real-time cooling requirements of the one or more hardware components of the computing unit, the anticipated cooling requirement of the one or more hardware components of the computing unit, or the real-time temperature data, or any combination thereof. In some embodiments, the system further comprises training the deep reinforcement learning model.

In some embodiments, the deep reinforcement learning model is trained utilizing one or more of: the incoming workload of the computing unit, the predicted incoming workload of the computing unit, the assessed functionality of the one or more cooling elements of the cooling system, real-time cooling requirements of the one or more hardware components of the computing unit, the anticipated cooling requirement of the one or more hardware components of the computing unit, or the real-time temperature data, or any combination thereof. In some embodiments, the operation parameter of the cooling system comprises one or more of: cooling element speed, cooling element power, cooling element orientation, cooling element flow rate, cooling element flow volume, cooling element flow direction, or any combination thereof. In some embodiments, the adjusting an operation parameter of a cooling system for the computing unit comprises one or more of: increasing the speed of one or more cooling elements, decreasing the speed of one or more cooling elements, increasing the power to one or more cooling elements, decreasing the power to one or more cooling elements, ceasing power to one or more cooling elements, initiating power to one or more cooling elements, modifying the orientation of one or more cooling elements, increasing liquid coolant flow rate of one or more cooling elements, decreasing liquid coolant flow rate of one or more cooling elements, increasing liquid coolant volume of one or more cooling elements, decreasing liquid coolant volume of one or more cooling elements, redirecting liquid coolant flow of one or more cooling elements, or any combination thereof.

In some embodiments, the computing unit, or the cooling system, or both, comprise one or more sensors. In some embodiments, the TCU is further configured to retrieve data from the one or more sensors of the computing unit, or the one or more sensors of the cooling system, or both. In some embodiments, the one or more sensors comprise one or more of: a temperature sensor, a network traffic sensor, an energy consumption sensor, or an operational sensor, or any combination thereof. In some embodiments, the operational sensor comprises one or more of: a movement sensor, a rotation sensor, a liquid flow sensor, or a signaling sensor, or any combination thereof.

In some embodiments, the TCU further comprises one or more artificial intelligence/machine learning engines. In some embodiments, the one or more artificial intelligence/machine learning engines are configured to accelerate processing of the deep reinforcement learning model. In some embodiments, the deep reinforcement learning model receives input from the BMC. In some embodiments, the BMC comprises a Graphic User Interface (GUI). In some embodiments, the BMC is configured to display to a user the cooling plan via the GUI. In some embodiments, the BMC is further configured to display to the user data from the one or more sensors via the GUI. In some embodiments, the BMC is further configured to display to the user one or more operational parameters of the cooling system via the GUI. In some embodiments, the BMC is configured to facilitate modification of the cooling plan by the user.

In some embodiments, the at least one processor is further configured to modify the command for adjusting an operation parameter of the cooling system based at least in part on the modification to the cooling plan by the user. In some embodiments, the deep reinforcement learning model is trained utilizing feedback input comprising the modification to the cooling plan by the user.

In some embodiments, the deep reinforcement learning model is trained utilizing feedback input data retrieved from the one or more sensors. In some embodiments, the data retrieved from the one or more sensors is generated by the one or more sensors subsequently to adjusting the operation parameter of the cooling system.

In some embodiments, the deep reinforcement learning model is further configured to generate an energy efficiency score of the cooling system. In some embodiments, the deep reinforcement learning model generates the energy efficiency score of the cooling system based at least in part on energy consumption of the cooling system and energy consumption of the computing unit. In some embodiments, the deep reinforcement learning model is further configured to generate a modified cooling plan based at least in part on the energy efficiency score of the cooling system. In some embodiments, the deep reinforcement learning model is trained utilizing the energy efficiency score of the cooling system.

Another aspect disclosed herein is a method for dynamic thermal management, the method comprising: (a) receiving real-time data related to one or more hardware components of a computing unit, wherein the real-time data comprises at least CPU data or memory usage indicative of an incoming workload of the computing unit; and (b) feeding the real-time data as input to a deep reinforcement learning model, and outputting a command for adjusting an operation parameter of a cooling system for the computing unit.

Additional aspects and advantages of the present disclosure will become readily apparent to those skilled in this art from the following detailed description, wherein only illustrative embodiments of the present disclosure are shown and described. As will be realized, the present disclosure is capable of other and different embodiments, and its several details are capable of modifications in various obvious respects, all without departing from the disclosure. Accordingly, the drawings and description are to be regarded as illustrative in nature, and not as restrictive.

### INCORPORATION BY REFERENCE

All publications, patents, and patent applications mentioned in this specification are herein incorporated by reference to the same extent as if each individual publication, patent, or patent application was specifically and individually indicated to be incorporated by reference. To the extent publications and patents or patent applications incorporated by reference contradict the disclosure contained in the specification, the specification is intended to supersede and/or take precedence over any such contradictory material.

### BRIEF DESCRIPTION OF THE DRAWINGS

The novel features of the disclosure are set forth with particularity in the appended claims. A better understanding of the features and advantages of the present disclosure will be obtained by reference to the following detailed description that sets forth illustrative embodiments, in which the principles of the disclosure are utilized, and the accompanying drawings (also “Figure” and “FIG.” herein), of which:

FIG. 1A illustrates exemplary data showing a comparison between cooling system operation using one or more machine learning models disclosed herein and cooling system operation at medium speed and at high speed.

FIG. 1B shows exemplary data concerning energy consumption of fan-based cooling systems using one or more machine learning models, compared to operating at medium fan speed and high fan speed.

FIG. 2 illustrates exemplary data showing annual carbon dioxide emissions of traditional cooling methods compared to cooling methods using AI-driven systems.

FIG. 3 illustrates an exemplary diagram of a Trusted Control/Compute (TCU) chipset.

FIG. 4A shows an exemplary process flow diagram pertaining to the cooling adjustment methods comprised herein.

FIG. 4B illustrates an exemplary process flow diagram pertaining to dynamic cooling adjustment methods comprised herein.

FIG. 5 shows an exemplary system architecture diagram pertaining to the systems disclosed herein.

FIG. 6 illustrates an example of a computing device; in this case, a device with one or more processors, memory, storage, and a network interface.

### DETAILED DESCRIPTION

While various embodiments of the invention have been shown and described herein, it will be obvious to those skilled in the art that such embodiments are provided by way of example only. Numerous variations, changes, and substitutions may occur to those skilled in the art without departing from the invention. It should be understood that various alternatives to the embodiments of the invention described herein may be employed.

### TERMS AND DEFINITIONS

As used herein, the singular forms “a,” “an,” and “the” include plural references unless the context clearly dictates otherwise. Any reference to “or” herein is intended to encompass “and/or” unless otherwise stated.

As used herein, the phrases “at least one,” “one or more,” and “and/or” are open-ended expressions that are both conjunctive and disjunctive in operation. For example, each of the expressions “at least one of A, B and C,” “at least one of A, B, or C,” “one or more of A, B, and C”, “one or more of A, B, or C” and “A, B, and/or C” means A alone, B alone, C alone, A and B together, A and C together, B and C together, or A, B and C together. As used herein, the phrase “at most three” can mean less than one, one, two, or three.

Reference throughout this specification to “some embodiments,” “further embodiments,” or “a particular embodiment,” means that a particular feature, structure, or characteristic described in connection with the embodiment is included in at least one embodiment. Thus, the appearances of the phrase “in some embodiments,” or “in further embodiments,” or “in a particular embodiment” in various places throughout this specification are not necessarily all referring to the same embodiment. Furthermore, the particular features, structures, or characteristics may be combined in any suitable manner in one or more embodiments

As used herein, the term “neural network” generally refers to a computational network composed of nodes. The nodes of the neural network may be connected as layers or graphs. In some embodiments, the neural network comprises an algorithm designed for solving a specific problem. In some embodiments, the neural network may comprise a generalizable algorithm to solve a range of problems. In some embodiments, the neural network may “learn” how to solve one or more problems.

As used herein, the term “deep reinforcement learning (DRL)” generally refers to a combination of deep learning and reinforcement learning. As used herein, the term “deep learning” generally refers to a computational network comprising pattern recognition and prediction elements. In some embodiments, the deep learning network may comprise a generalizable algorithm to solve a range of problems. In some embodiments, the deep learning network may “learn” how to solve one or more problems. In some embodiments, the deep learning network may “learn” how to solve one or more problems based at least in part on using a training data set. As used herein, the term “reinforcement learning” generally refers to a computational network comprising pattern recognition and prediction elements to “maximize” a “reward”. In some embodiments, the reinforcement learning network may “learn” how to solve one or more problems. In some embodiments, the reinforcement learning network may dynamically “learn” how to solve one or more problems by adjusting actions based on continuous feedback.

### Systems for Adjustable Cooling of Hardware Units

The present disclosure provides systems and methods addressing the above issues in the traditional cooling systems. Systems and methods herein improve the cooling efficiency by providing a Dynamic Thermal Management (DTM) system which beneficially allows fans to be controlled in near real-time, increasing and decreasing speed based on real-time, actual operating conditions. In particular, the DTM system may combine deep learning algorithms such as deep reinforcement learning (DRL) and a proprietary trusted control/compute unit (TCU) and achieves improved energy efficiency than traditional fan control methods. The DTM system provides a significant reduction in power consumption and a corresponding decrease in data center emissions.

Unlike conventional thermal control based on closed-loop feedback where delay may occur due to system response time, the present disclosure provides DTM system capable of making proactive cooling adjustments by anticipating cooling needs based on incoming server workloads. This beneficially allows for preemptive adjustments that minimize feedback loop delays and ensure efficient cooling. In particular, the DTM system may employ predictive artificial intelligence (AI) models and deep reinforcement learning technologies to improve the accuracy of the cooling needs prediction. Systems herein may continuously monitor server temperature and workloads in real time, allowing for dynamic adjustment of the cooling system capacity (e.g., fan speeds) to match real-time cooling requirements and reduce unnecessary power consumption.

Disclosed herein are systems and methods for adjusting cooling of computing unit. In an aspect, the present disclosure provides a computer-implemented system comprising at least one processor, a memory, and instructions executable by the at least one processor configured to perform operations. In some embodiments, the operations can comprise receiving real-time data related to one or more hardware components of a computing unit, wherein the real-time data comprises at least CPU data or memory usage indicative of an incoming workload of the computing unit. In some embodiments, the operations can comprise receiving real-time data related to one or more hardware components of a computing unit.

In some embodiments, the operations can comprise associating temperature data. In some cases, the real-time temperature data can pertain to computing unit. In some cases, the temperature data can comprise one or more of: temperature stability, peak temperature, thermal gradients, temperature change response time, or any combination thereof. In some cases, the operations of the computer-implemented system can comprise determining a workload. In some embodiments, the workload can be determined for the computing unit. In some embodiments, the operations of the computer-implemented system can comprise generating a cooling plan. In some cases, the cooling plan can be generated for the computing unit. In some cases, the cooling plan can be based at least in part on the associated with hardware temperature data. In some cases, the cooling plan can be based at least in part on the determined workload. In some cases, the cooling plan can be based at least in part on the associated with hardware temperature data and the determined workload. In some embodiments, the operations can further comprise communicating with a cooling system. In some cases, communicating with a cooling system can comprise adjusting one or more cooling elements of the cooling system. In some cases, the one or more elements of the cooling system can be adjusted based at least in part on the generated cooling plan.

In some cases, the computing unit can comprise a memory hardware units. In some embodiments, the computing unit can be a server, or a data center can comprise a plurality of servers. In some embodiments, the computing unit can comprise one or more servers. In some embodiments, the computing unit can comprise a data center. In some cases, the data center can comprise one or more of: an enterprise data center, a multi-tenant data center, a colocation data center, a hyperscale data center, an edge data center, a micro data center, a container data center, or a modular data center, or any combination thereof. In some cases, the data center can comprise a cloud data center. In some embodiments, the data center can comprise a plurality of hardware units such as servers. In some cases, the data center can comprise less than 100 hardware units such as servers. In some cases, the data center can comprise more than 100 hardware units such as servers. In some cases, the data center can comprise about 100 servers, 200 servers, 300 servers, 400 servers, 500 servers, 600 servers, 700 servers, 800 servers, 900 servers, 1,000 servers, 1,100 servers, 1,200 servers, 1,300 servers, 1,400 servers, 1,500 servers, 1,600 servers, 1,700 servers, 1,800 servers, 1,900 servers, 2,000 servers, 2,100 servers, 2,200 servers, 2,300 servers, 2,400 servers, 2,500 servers, 2,600 servers, 2,700 servers, 2,800 servers, 2,900 servers, 3,000 servers, 3,100 servers, 3,200 servers, 3,300 servers, 3,400 servers, 3,500 servers, 3,600 servers, 3,700 servers, 3,800 servers, 3,900 servers, 4,000 servers, 4,100 servers, 4,200 servers, 4,300 servers, 4,400 servers, 4,500 servers, 4,600 servers, 4,700 servers, 4,800 servers, 4,900 servers, 5,000 servers, 5,100 servers, 5,200 servers, 5,300 servers, 5,400 servers, 5,500 servers, 5,600 servers, 5,700 servers, 5,800 servers, 5,900 servers, 6,000 servers, 6,100 servers, 6,200 servers, 6,300 servers, 6,400 servers, 6,500 servers, 6,600 servers, 6,700 servers, 6,800 servers, 6,900 servers, 7,000 servers, 7,100 servers, 7,200 servers, 7,300 servers, 7,400 servers, 7,500 servers, 7,600 servers, 7,700 servers, 7,800 servers, 7,900 servers, 8,000 servers, 8,100 servers, 8,200 servers, 8,300 servers, 8,400 servers, 8,500 servers, 8,600 servers, 8,700 servers, 8,800 servers, 8,900 servers, 9,000 servers, 9,100 servers, 9,200 servers, 9,300 servers, 9,400 servers, 9,500 servers, 9,600 servers, 9,700 servers, 9,800 servers, 9,900 servers, 10,000 servers, or more than 10,000 servers, including increments therein. In some cases, the data center can comprise about 10,000 servers, 11,000 servers, 12,000 servers, 13,000 servers, 14,000 servers, 15,000 servers, 16,000 servers, 17,000 servers, 18,000 servers, 19,000 servers, 20,000 servers, 21,000 servers, 22,000 servers, 23,000 servers, 24,000 servers, 25,000 servers, 26,000 servers, 27,000 servers, 28,000 servers, 29,000 servers, 30,000 servers, 31,000 servers, 32,000 servers, 33,000 servers, 34,000 servers, 35,000 servers, 36,000 servers, 37,000 servers, 38,000 servers, 39,000 servers, 40,000 servers, 41,000 servers, 42,000 servers, 43,000 servers, 44,000 servers, 45,000 servers, 46,000 servers, 47,000 servers, 48,000 servers, 49,000 servers, 50,000 servers, 51,000 servers, 52,000 servers, 53,000 servers, 54,000 servers, 55,000 servers, 56,000 servers, 57,000 servers, 58,000 servers, 59,000 servers, 60,000 servers, 61,000 servers, 62,000 servers, 63,000 servers, 64,000 servers, 65,000 servers, 66,000 servers, 67,000 servers, 68,000 servers, 69,000 servers, 70,000 servers, 71,000 servers, 72,000 servers, 73,000 servers, 74,000 servers, 75,000 servers, 76,000 servers, 77,000 servers, 78,000 servers, 79,000 servers, 80,000 servers, 81,000 servers, 82,000 servers, 83,000 servers, 84,000 servers, 85,000 servers, 86,000 servers, 87,000 servers, 88,000 servers, 89,000 servers, 90,000 servers, 91,000 servers, 92,000 servers, 93,000 servers, 94,000 servers, 95,000 servers, 96,000 servers, 97,000 servers, 98,000 servers, 99,000 servers, 100,000 servers, or more than 100,000 servers, including increments therein. In some embodiments, the data center can comprise about 110,000 servers, 120,000 servers, 130,000 servers, 140,000 servers, 150,000 servers, 160,000 servers, 170,000 servers, 180,000 servers, 190,000 servers, 200,000 servers, 210,000 servers, 220,000 servers, 230,000 servers, 240,000 servers, 250,000 servers, 260,000 servers, 270,000 servers, 280,000 servers, 290,000 servers, 300,000 servers, 310,000 servers, 320,000 servers, 330,000 servers, 340,000 servers, 350,000 servers, 360,000 servers, 370,000 servers, 380,000 servers, 390,000 servers, 400,000 servers, 410,000 servers, 420,000 servers, 430,000 servers, 440,000 servers, 450,000 servers, 460,000 servers, 470,000 servers, 480,000 servers, 490,000 servers, 500,000 servers, 510,000 servers, 520,000 servers, 530,000 servers, 540,000 servers, 550,000 servers, 560,000 servers, 570,000 servers, 580,000 servers, 590,000 servers, 600,000 servers, 610,000 servers, 620,000 servers, 630,000 servers, 640,000 servers, 650,000 servers, 660,000 servers, 670,000 servers, 680,000 servers, 690,000 servers, 700,000 servers, 710,000 servers, 720,000 servers, 730,000 servers, 740,000 servers, 750,000 servers, 760,000 servers, 770,000 servers, 780,000 servers, 790,000 servers, 800,000 servers, 810,000 servers, 820,000 servers, 830,000 servers, 840,000 servers, 850,000 servers, 860,000 servers, 870,000 servers, 880,000 servers, 890,000 servers, 900,000 servers, 910,000 servers, 920,000 servers, 930,000 servers, 940,000 servers, 950,000 servers, 960,000 servers, 970,000 servers, 980,000 servers, 990,000 servers, 1,000,000 servers, or more than 1,000,000 servers, including increments therein.

In some embodiments, the computing unit such as servers can be utilized in artificial intelligence/machine learning (AI/ML) architecture. In some cases, the computing unit such as servers can be utilized in cloud computing architecture. In some cases, the computing unit such as servers can be utilized in enterprise computing architecture. In some cases, the computing unit such as servers can be utilized in blockchain data architecture. In some cases, the computing unit such as servers can comprise one or more databases such as secure databases. In some cases, the AI/ML architecture can comprise a deep reinforcement learning model (DRM).

In some embodiments, the real-time data can be collected by a Baseboard Management Controller (BMC) and wherein the BMC can be integrated into a chipset. In some embodiments, the chipset can comprise a plurality of connected chips. In some embodiments, the chipset can comprise two chips, three chips, four chips, five chips, six chips, seven chips, eight chips, nine chips, ten chips, or more than ten chips. In some embodiments, the chips can be communicatively coupled. In some embodiments, the chipset can be a Trusted Control/Compute Unit (TCU). In some embodiments, the processor can be integrated into the TCU. In some embodiments, the processor can comprise one or more programmable artificial intelligence (AI) engines. In some embodiments, the chipset can further comprise a secure Network Interface Card (secure-NIC). In some cases, the secure-NIC can comprise one or more security modules or programs. In some embodiments, the chipset can further comprise a hardware Root of Trust (HROT), or a Trusted Platform Module (TPM), or both. In some embodiments, the secure-NIC, or the HROT, or the TPM, or any combination thereof, can be configured to bypass one or more security parameters of the cooling system.

In some embodiments, the real-time data indicative of the incoming workload of the computing unit can comprise one or more of: amount of queries, CPU usage, memory usage, disk input and output (disk I/O) operations, network traffic, server performance counters, or request rates, or any combination thereof. In some embodiments, determining the workload of the computing unit can comprise processing the incoming workload data of each of the computing unit. In some embodiments, the incoming workload data of each of the computing unit can comprise one or more of: amount of queries, CPU usage, memory usage, disk input and output (disk I/O) operations, network traffic, server performance counters, or request rates, or any combination thereof. In some embodiments, the one or more processors can be configured to query the computing unit to retrieve workload data. In some cases, the incoming workload data of each of the computing unit can comprise querying the computing unit over a period of time to retrieve the incoming workload data. In some cases, the querying can be repeated over a time interval. In some cases, the system can be configured to query the computing unit on an individual basis. In some cases, the system can be configured to query the computing unit every less than 1 second interval, every 1 second, every 2 seconds, every 3 seconds, every 4 seconds, every 5 seconds, every 6 seconds, every 7 seconds, every 8 seconds, every 9 seconds, every 10 seconds, every 11 seconds, every 12 seconds, every 13 seconds, every 14 seconds, every 15 seconds, every 16 seconds, every 17 seconds, every 18 seconds, every 19 seconds, every 20 seconds, every 21 seconds, every 22 seconds, every 23 seconds, every 24 seconds, every 25 seconds, every 26 seconds, every 27 seconds, every 28 seconds, every 29 seconds, every 30 seconds, every 31 seconds, every 32 seconds, every 33 seconds, every 34 seconds, every 35 seconds, every 36 seconds, every 37 seconds, every 38 seconds, every 39 seconds, every 40 seconds, every 41 seconds, every 42 seconds, every 43 seconds, every 44 seconds, every 45 seconds, every 46 seconds, every 47 seconds, every 48 seconds, every 49 seconds, every 50 seconds, every 51 seconds, every 52 seconds, every 53 seconds, every 54 seconds, every 55 seconds, every 56 seconds, every 57 seconds, every 58 seconds, every 59 seconds, or every 60 seconds, including increments therein. In some cases, the system can be configured to query the computing unit at an interval of every 1 minute, every 2 minutes, every 3 minutes, every 4 minutes, every 5 minutes, every 6 minutes, every 7 minutes, every 8 minutes, every 9 minutes, every 10 minutes, every 11 minutes, every 12 minutes, every 13 minutes, every 14 minutes, every 15 minutes, every 16 minutes, every 17 minutes, every 18 minutes, every 19 minutes, every 20 minutes, every 21 minutes, every 22 minutes, every 23 minutes, every 24 minutes, every 25 minutes, every 26 minutes, every 27 minutes, every 28 minutes, every 29 minutes, every 30 minutes, every 31 minutes, every 32 minutes, every 33 minutes, every 34 minutes, every 35 minutes, every 36 minutes, every 37 minutes, every 38 minutes, every 39 minutes, every 40 minutes, every 41 minutes, every 42 minutes, every 43 minutes, every 44 minutes, every 45 minutes, every 46 minutes, every 47 minutes, every 48 minutes, every 49 minutes, every 50 minutes, every 51 minutes, every 52 minutes, every 53 minutes, every 54 minutes, every 55 minutes, every 56 minutes, every 57 minutes, every 58 minutes, every 59 minutes, or every 60 minutes, including increments therein. In some cases, the system can be configured to query the computing unit at an interval of every 1 hour, every 2 hours, every 3 hours, every 4 hours, every 5 hours, every 6 hours, every 7 hours, every 8 hours, every 9 hours, every 10 hours, every 11 hours, every 12 hours, every 13 hours, every 14 hours, every 15 hours, every 16 hours, every 17 hours, every 18 hours, every 19 hours, every 20 hours, every 21 hours, every 22 hours, every 23 hours, every 24 hours, every 25 hours, every 26 hours, every 27 hours, every 28 hours, every 29 hours, every 30 hours, every 31 hours, every 32 hours, every 33 hours, every 34 hours, every 35 hours, every 36 hours, every 37 hours, every 38 hours, every 39 hours, every 40 hours, every 41 hours, every 42 hours, every 43 hours, every 44 hours, every 45 hours, every 46 hours, every 47 hours, or every 48 hours, including increments therein. In some cases, the system can be configured to query the computing unit at an interval of every 3 days, every 4 days, every 5 days, every 6 days, every 7 days, every 2 weeks, every 3 weeks, every 4 weeks, every 1 month, every 2 months, every 3 months, or at a longer interval than every 3 months, including increments therein.

In some embodiments, the real-time data can further comprise real-time temperature data. In some embodiments, the real-time temperature data can comprise real-time data relating to temperature of the one or more hardware components of the computing unit. In some embodiments, associating hardware temperature data can comprise associating received temperature data to each of the computing unit. In some embodiments, associating hardware temperature data can comprise assigning one or more temperature data values to each of the computing unit. In some cases, the real-time temperature data can be associated with the entirety of each of the computing unit. In some cases, the real-time temperature data can be associated with a component or area section of each of the computing unit. In some cases, the real-time temperature data can be associated with a plurality of the computing unit. In some cases, the real-time temperature data can be associated with a subset of a plurality of the computing unit. In some cases, the real-time temperature data can be associated with the computing unit based at least in part on the location of the computing unit. In some cases, the real-time temperature data can be associated with the computing unit based at least in part on identifying data associated with the real-time temperature data. In some cases, the temperature data can comprise one or more of: temperature stability, peak temperature, thermal gradients, temperature change response time, or any combination thereof. In some cases, the identifying data can comprise data relating to identification of an individual one or more hardware components of a computing unit of the computing unit. In some cases, the identifying data can comprise one or more of: a unique identification number or string associated with one or more hardware components of a computing unit, unique spatial coordinates of one or more hardware components of a computing unit, a unique IP address of one or more hardware components of a computing unit, or any combination thereof.

In some embodiments, the real-time temperature data can be received by the one or more processors of the system. In some embodiments, the real-time temperature data can be received by the TCU. In some embodiments, the real-time temperature data can be received by the BMC.

In some embodiments, the one or more processors can be further configured to query the computing unit for the real-time temperature data. In some embodiments, the real-time temperature data can be received from each of the computing unit over a period of time. In some embodiments, associating hardware temperature data comprises querying the computing unit for the real-time temperature data. In some embodiments, the computing unit are queried for the real-time temperature data repeatedly over an interval of time. In some cases, the querying can be repeated over a time interval. In some cases, the system can be configured to query the computing unit on an individual basis. In some cases, the system can be configured to query the computing unit every less than 1 second interval, every 1 second, every 2 seconds, every 3 seconds, every 4 seconds, every 5 seconds, every 6 seconds, every 7 seconds, every 8 seconds, every 9 seconds, every 10 seconds, every 11 seconds, every 12 seconds, every 13 seconds, every 14 seconds, every 15 seconds, every 16 seconds, every 17 seconds, every 18 seconds, every 19 seconds, every 20 seconds, every 21 seconds, every 22 seconds, every 23 seconds, every 24 seconds, every 25 seconds, every 26 seconds, every 27 seconds, every 28 seconds, every 29 seconds, every 30 seconds, every 31 seconds, every 32 seconds, every 33 seconds, every 34 seconds, every 35 seconds, every 36 seconds, every 37 seconds, every 38 seconds, every 39 seconds, every 40 seconds, every 41 seconds, every 42 seconds, every 43 seconds, every 44 seconds, every 45 seconds, every 46 seconds, every 47 seconds, every 48 seconds, every 49 seconds, every 50 seconds, every 51 seconds, every 52 seconds, every 53 seconds, every 54 seconds, every 55 seconds, every 56 seconds, every 57 seconds, every 58 seconds, every 59 seconds, or every 60 seconds, including increments therein. In some cases, the system can be configured to query the computing unit at an interval of every 1 minute, every 2 minutes, every 3 minutes, every 4 minutes, every 5 minutes, every 6 minutes, every 7 minutes, every 8 minutes, every 9 minutes, every 10 minutes, every 11 minutes, every 12 minutes, every 13 minutes, every 14 minutes, every 15 minutes, every 16 minutes, every 17 minutes, every 18 minutes, every 19 minutes, every 20 minutes, every 21 minutes, every 22 minutes, every 23 minutes, every 24 minutes, every 25 minutes, every 26 minutes, every 27 minutes, every 28 minutes, every 29 minutes, every 30 minutes, every 31 minutes, every 32 minutes, every 33 minutes, every 34 minutes, every 35 minutes, every 36 minutes, every 37 minutes, every 38 minutes, every 39 minutes, every 40 minutes, every 41 minutes, every 42 minutes, every 43 minutes, every 44 minutes, every 45 minutes, every 46 minutes, every 47 minutes, every 48 minutes, every 49 minutes, every 50 minutes, every 51 minutes, every 52 minutes, every 53 minutes, every 54 minutes, every 55 minutes, every 56 minutes, every 57 minutes, every 58 minutes, every 59 minutes, or every 60 minutes, including increments therein. In some cases, the system can be configured to query the computing unit at an interval of every 1 hour, every 2 hours, every 3 hours, every 4 hours, every 5 hours, every 6 hours, every 7 hours, every 8 hours, every 9 hours, every 10 hours, every 11 hours, every 12 hours, every 13 hours, every 14 hours, every 15 hours, every 16 hours, every 17 hours, every 18 hours, every 19 hours, every 20 hours, every 21 hours, every 22 hours, every 23 hours, every 24 hours, every 25 hours, every 26 hours, every 27 hours, every 28 hours, every 29 hours, every 30 hours, every 31 hours, every 32 hours, every 33 hours, every 34 hours, every 35 hours, every 36 hours, every 37 hours, every 38 hours, every 39 hours, every 40 hours, every 41 hours, every 42 hours, every 43 hours, every 44 hours, every 45 hours, every 46 hours, every 47 hours, or every 48 hours, including increments therein. In some cases, the system can be configured to query the computing unit at an interval of every 3 days, every 4 days, every 5 days, every 6 days, every 7 days, every 2 weeks, every 3 weeks, every 4 weeks, every 1 month, every 2 months, every 3 months, or at a longer interval than every 3 months, including increments therein.

In some embodiments, the retrieved temperature data, or workload data, or both, can be stored in the memory of the system. In some cases, the temperature data can comprise one or more of: temperature stability, peak temperature, thermal gradients, temperature change response time, or any combination thereof. In some cases, the real-time temperature data, the incoming workload data or both, can be stored as a vector, an array, or as a group of data values. In some cases, the real-time temperature data and the incoming workload data can be paired, grouped, or otherwise linked together for each of the computing unit. In some cases, the real-time temperature data and the incoming workload data can be paired, grouped, or otherwise linked based at least in part on a time associated with the real-time temperature data or the incoming workload data or both. In some cases, the time can comprise the time the real-time temperature data or the incoming workload data or both, was retrieved or received by the system from the computing unit.

In some embodiments, the deep reinforcement learning model can be configured to generate a cooling plan based at least in part on the real-time temperature data. In some embodiments, the cooling plan can be generated based at least in part on real-time cooling requirements of the one or more hardware components of the computing unit. In some embodiments, generating the cooling plan for the computing unit can comprise determining real-time cooling requirements of the computing unit. In some cases, real-time cooling requirements can be determined for a component or area of the computing unit. In some cases, real-time cooling requirements can be determined for a singular one or more hardware components of a computing unit of the computing unit. In some cases, real-time cooling requirements can be determined for a plurality of the computing unit. In some embodiments, determining real-time cooling requirements of the computing unit can comprise comparing the real-time temperature data of the computing unit to a predetermined target temperature of the computing unit. In some cases, the real-time temperature data of computing unit comprises temperature data associated with a selected time point. In some cases, the real-time temperature data can comprise temperature data received or received from the computing unit at the selected time point. In some cases, the predetermined target temperature can comprise a range of target temperatures. In some cases, the predetermined target temperature can be determined based at least in part on a standardized temperature or range of temperatures associated with the computing unit. In some cases, the predetermined target temperature can be determined based at least in part on manufacturer specification or recommendations for operating temperature of the computing unit. In some cases, the predetermined target temperature can be determined based at least in part on one or more of: environmental temperature, characteristics of the computing unit such as age or model of the computing unit, stored previous temperature data, or any combination thereof. In some embodiments, the temperature value can comprise a value in Celsius, Fahrenheit, Kelvin, or another temperature unit.

In some embodiments, the real-time cooling requirements of the one or more hardware components of the computing unit are determined based at least in part on determining a disparity between the real-time temperature data of the one or more hardware components of the computing unit and a predetermined target temperature of the respective one or more hardware components of the computing unit. In some embodiments, determining cooling requirements of the computing unit can further comprise determining a temperature differential. In some embodiments, the temperature differential can comprise an integer with a positive value or a negative value, or zero. In some embodiments, the temperature differential can comprise an absolute value. In some embodiments, the temperature differential can comprise a difference in temperature required for reaching the predetermined target temperature for each of the computing unit. In some embodiments, the cooling plan can be generated based at least in part on the determined real-time cooling requirements of the computing unit. In some embodiments, determining the real-time cooling requirements of the one or more hardware components of the computing unit can further comprise determining a temperature differential associated with the disparity between the real-time temperature data and the predetermined target temperature for each of the one or more hardware components of the computing unit. In some embodiments, the command for adjusting an operation parameter of a cooling system for the computing unit can be output based at least in part on the determined real-time cooling requirements of the one or more hardware components of the computing unit.

In some embodiments, the deep reinforcement learning model can be configured to assess functionality of the one or more cooling elements of the cooling system. In some embodiments, generating the cooling plan can comprise assessing functionality of the one or more cooling elements of the cooling system. In some embodiments, the one or more cooling elements of the cooling system can comprise one or more of: fans, heat sinks, liquid cooling distribution components, liquid cooling pump components, air conditioning components, or air handlers, or any combination thereof. In some cases, assessing functionality of the one or more cooling elements of the cooling system can comprise determining whether each of the one or more cooling elements of the cooling system is functional upon receiving power. In some cases, assessing functionality of the one or more cooling elements of the cooling system can comprise determining the time of the one or more cooling elements of the cooling system to achieve the temperature differential. In some embodiments, assessing the functionality of the one or more cooling elements of the cooling system can comprise assessing one or more of: temperature data, fan speed data, power supply data, voltage level data, or power consumption data, or any combination thereof.

In some embodiments, the command for adjusting an operation parameter of a cooling system for the computing unit can be generated based at least in part on the real-time data indicative of the incoming workload of the computing unit. In some embodiments, generating the cooling plan can comprise predicting an incoming workload based at least in part on the incoming workload data. In some embodiments, the deep reinforcement learning model can be configured to predict an incoming workload of the computing unit based at least in part on the real-time data. In some embodiments, the incoming workload can comprise a future workload of the computing unit. In some embodiments, the incoming workload can comprise one or more incoming server workloads. In some cases, the incoming workload can comprise a predicted workload of the computing unit. In some embodiments, the incoming workload can be predicted based at least in part on the real-time workload data. In some cases, the incoming workload can be predicted by the system based at least in part on one or more of: predicted amount of queries, predicted CPU usage, predicted memory usage, predicted disk input and output (disk I/O) operations, predicted network traffic, server performance counters, or predicted request rates, or any combination thereof.

In some embodiments, the system can further comprise one or more artificial intelligence/machine learning models (AI/ML). In some embodiments, the one or more AI/ML models can be configured to predict the incoming workload. In some cases, the AI/ML models such as DRL models can be configured to predict the incoming workload based at least in part on predicted cooling needs of the computing unit or components thereof. In some cases, the AI/ML models such as DRL models can be configured to predict the incoming workload based at least in part on one or more values of the real-time workload. In some embodiments, the AI/ML model can comprise a deep reinforcement learning model (DRL model). In some cases, the DRL model can be based on a large language learning (LLM) model.

In some cases, the DRL model can be trained using one or more workload combinations. In some cases, the one or more workload combinations can comprise CPU-intensive workload data, memory-intensive workload data, I/O-bound workload data, and mixed workloads. In some cases, the workload combinations can be generated based at least in part on incoming workload data. In some cases, the DRL model can be configured to group incoming workload data into one or more workload combination groups. In some cases, the incoming workload data can be grouped based at least in part on the operational data type or operational data values, or both, of the incoming workload data.

In some cases, the DRL model can be trained utilizing adaptive workload stress testing. In some cases, adaptive workload stress testing can comprise outputting a command for adjusting an operation parameter of a cooling system outside established performance limits of the cooling system. In some cases, the DRL model can receive feedback data comprising failure data concerning the cooling system when operated outside established performance limits. In some cases, the performance limits can be established as preset parameters. In some cases, the performance limits can be determined by the DRL model. In some cases, the performance limits can be dynamic parameters. In some cases, the performance limits can be modified by the DRL model.

In some embodiments, the deep reinforcement learning model can be further configured to predict an anticipated cooling requirement of the one or more hardware components of the computing unit based at least in part on the predicted incoming workload. In some embodiments, the deep reinforcement learning model can be further configured to generate the cooling plan based at least in part on one or more of: the predicted incoming workload of the computing unit, the assessed functionality of the one or more cooling elements of the cooling system, the real-time cooling requirements of the one or more hardware components of the computing unit, the anticipated cooling requirement of the one or more hardware components of the computing unit, or the real-time temperature data, or any combination thereof.

In some embodiments, the DRL model may be trained to generate the cooling plan. In some embodiments, the DRL model can generate the cooling plan based at least in part on the predict of the incoming workload. In some embodiments, the cooling plan can comprise one or more of: predicted cooling needs based on the incoming workload, determined preemptive adjustments to operation of one or more components of the cooling system, predicted temperature values, or target adjustment of one or more components of the cooling system, or any combination thereof. In some embodiments, the cooling plan can comprise a dynamic cooling plan. In some embodiments, the dynamic cooling plan can be modified based on the predicted incoming workload, the predicted temperature values, or both.

In some embodiments, the one or more artificial intelligence/machine learning (AI/ML) models, such as deep reinforcement learning models (DRL models) can comprise one or more deep reinforcement learning (DRL) models. In some cases, the one or more DRL models can comprise one or more model-based reinforcement learning algorithms. In some cases, the one or more DRL models can comprise one or more model-free algorithms. In some embodiments, the one or more DRL models can comprise one or more of: Markov Decision Process (MDP) algorithms, Bellman Equations, value iteration dynamic programming algorithms, policy iteration value dynamic programming algorithms, or Q-Learning algorithms, or any combination thereof.

In some embodiments, the system can further comprise training the deep reinforcement learning model. In some embodiments, the deep reinforcement learning model can be trained utilizing one or more of: the incoming workload of the computing unit, the predicted incoming workload of the computing unit, the assessed functionality of the one or more cooling elements of the cooling system, real-time cooling requirements of the one or more hardware components of the computing unit, the anticipated cooling requirement of the one or more hardware components of the computing unit, or the real-time temperature data, or any combination thereof. In some embodiments, deep reinforcement learning (DRL) model may be developed to dynamically control server fan speeds or generate a control instruction for controlling other type of cooling elements. In some cases, the DRL model may take as input, the various workload data such as the amount of queries, CPU usage data, memory usage data, disk I/O data, network traffic data, server performance counters, request rates, and make an inference about the fan speeds. In some cases, input to the DRL model may be data collected by the Baseboard Management Controller (BMC) such as data collected about various hardware components including, but not limited to, temperature sensors, fan speeds, power supplies, and voltage levels, providing real-time information about the server's overall health and status. In some embodiments, the BMC can receive input from a rack management controller (RMC). In some cases, the BMC can receive real-time information comprising states of rack-level hardware components from the RMC. In some cases, the real-time information comprising states of rack-level hardware components can comprise one or more of: temperature of the rack-level hardware components, space between the rack-level hardware components, airflow between racks, variation in rack positions, or performance data of the rack-level hardware components. In some cases, the BMC can receive data from the RMC grouped by rack number or rack identification.

The DRL training process may comprise training the model or DRL agents to learn to maximize rewards through experience. The DRL agents may develop sophisticated strategies that often surpass human-designed solutions. Unlike traditional supervised learning methods that rely on pre-labeled datasets, the DRL learning process operates on a principle of exploration and exploitation, where a DRL agent learns optimal behaviors through interaction with its surroundings, taking actions and receiving feedback. The DRL agent refines its strategy through repeated iterations, gradually improving its performance without explicit instruction on each state's “correct” action. This “trial-and-error” approach distinguishes DRL systems from other machine learning techniques because they accumulate knowledge through active engagement with their environment rather than being trained on a static dataset. In some cases, the DRL model can modify one or more rules or policies under which it operates based on feedback data received by the DRL model. In some cases, the DRL can calculate a reward signal based at least in part on an energy efficiency score, such as an increase in the energy efficiency score.

The DRL's continuous learning over experience ensures the controller's versatility in accommodating diverse and dynamic computation performance with minimal energy bills. The DRL agent once trained, is capable of understanding thermal features with complex patterns and dependencies affecting fan speed requirements, which allows the system to preemptively rather than reactively adjust fan controls to prevent overheating, optimizing the balance between cooling performance and energy efficiency. As an example, during the deep reinforcement learning, reward signal may be calculated based on the real-time state of the system (e.g., temperature) and the action taken by the agent (e.g., adjusting fan speed) and the reward function may include components that reward staying within a temperature range while penalizing excessive energy usage. As an example, the reward function may comprise a negative reward proportional to the absolute difference between the real-time temperature and the desired temperature and a negative reward proportional to the amount of energy used by the cooling system.

In some embodiments, the DRL model can be trained prior to receiving data from the computing unit. In some cases, the DRL model can be trained prior to receiving data from the cooling unit. In some cases, the DRL model can be trained prior to receiving data from one or more sensors. In some cases, the DRL model can be trained prior to receiving data from the BMC. In some cases, the DRL model can be trained prior to generating a cooling plan. In some cases, the DRL model can be trained prior to outputting a command for adjusting an operation parameter of a cooling system.

The training data used for the DRL may ensure the agent focusing on decision-making processes in dynamic environments allowing for a more adaptable and intuitive AI systems. Data collection for model training involves pulling temperature and cooling performance data from server sensors (e.g., sensor data collected at five-second intervals over an extended period), which are important for training the DRL-based DTM model on diverse and intense workload conditions. In some embodiments, the one or more artificial intelligence/machine learning (AI/ML) models, such as deep reinforcement learning models (DRL models) can be trained utilizing the associated with hardware temperature data and the incoming workload data. In some embodiments, the one or more AI/ML models can be trained using data from one or more sensors. In some cases, the one or more sensors can be associated with each of the computing unit. In some cases, the DRL can receive data comprising the location of one or more sensors relative to one or more hardware components of the computing unit, or other sensors, or both. In some embodiments, the one or more AI/ML models can be trained using one or more of: temperature data, fan speed data, power supply data, battery charge data, voltage level data, or any combination thereof, relating to each of the computing unit, or a component thereof. In some cases, the data used for training can be received by the one or more AI/ML models of the system at an interval of five seconds. In some cases, the data used for training can be received by the one or more AI/ML models at an interval of less than 1 second, 1 second, 2 seconds, 3 seconds, 4 seconds, 5 seconds, 6 seconds, 7 seconds, 8 seconds, 9 seconds, 10 seconds, 11 seconds, 12 seconds, 13 seconds, 14 seconds, 15 seconds, or more than 15 seconds, including increments therein. In some cases, the data used for training can be received by the one or more AI/ML models of the system for a duration of about 5 seconds, 10 seconds, 15 seconds, 20 seconds, 25 seconds, 30 seconds, 35 seconds, 40 seconds, 45 seconds, 50 seconds 55 seconds, 60 seconds, 1 minute, 2 minutes, 3 minutes, 4 minutes, 5 minutes, or more than about 5 minutes, including increments therein.

In some embodiments, generating the cooling plan can further comprise predicting an adjusted cooling requirement for the computing unit. In some embodiments, predicting the adjusted cooling requirement for the computing unit could be performed by utilizing the one or more artificial intelligence/machine learning (AI/ML) models, such as deep reinforcement learning models (DRL models). In some embodiments, the one or more artificial intelligence/machine learning (AI/ML) models, such as deep reinforcement learning models (DRL models) can be configured to predict the adjusted cooling requirement based at least in part on one or more of: the real-time cooling requirements, the temperature differential, or the predicted incoming workload, or any combination thereof. In some embodiments, the adjusted cooling requirement can comprise a predicted cooling requirement pertaining to the computing unit. In some cases, the adjusted cooling requirement can comprise a future predicted cooling requirement pertaining to the computing unit. In some cases, the AI/ML models such as DRL models can be configured to generate the adjusted cooling requirement by assessing the predicted incoming workload in comparison with the real-time workload. In some cases, the AI/ML models such as DRL models can be configured to generate the adjusted cooling requirement by assessing the temperature differential at one or more time points. In some embodiments, the one or more artificial intelligence/machine learning (AI/ML) models may be trained to generate the cooling plan based at least in part on the predicted adjusted cooling requirement and the assessed functionality of the one or more cooling elements of the cooling system. In some cases, the adjusted cooling requirement can be predicted based at least in part on the functionality of the one or more cooling elements of the cooling system.

In some embodiments, the operation parameter of the cooling system can comprise one or more of: cooling element speed, cooling element power, cooling element orientation, cooling element flow rate, cooling element flow volume, cooling element flow direction, or any combination thereof. In some embodiments, the adjusting an operation parameter of a cooling system for the computing unit can comprise one or more of: increasing the speed of one or more cooling elements, decreasing the speed of one or more cooling elements, increasing the power to one or more cooling elements, decreasing the power to one or more cooling elements, ceasing power to one or more cooling elements, initiating power to one or more cooling elements, modifying the orientation of one or more cooling elements, increasing liquid coolant flow rate of one or more cooling elements, decreasing liquid coolant flow rate of one or more cooling elements, increasing liquid coolant volume of one or more cooling elements, decreasing liquid coolant volume of one or more cooling elements, redirecting liquid coolant flow of one or more cooling elements, or any combination thereof. In some embodiments, the adjustment of the one or more cooling elements of the cooling system can comprise increasing or decreasing the capacity of the cooling system such as one or more of: increasing the speed of one or more fans, decreasing the speed of one or more fans, ceasing power to one or more fans, initiating power to one or more fans, increasing liquid coolant flow, decreasing liquid coolant flow, redirecting liquid coolant flow, or any combination thereof. In some cases, the adjustment of the one or more cooling elements can comprise activating one or more fans, or deactivating one or more fans, or both, without changing power to the fans. In some embodiments, the liquid coolant can comprise one or more of: water, purified water, deionized water, propylene glycol, ethylene glycol, dielectric fluids, mineral oil, engineered dielectric fluids, nanofluids, or fluorocarbon-based fluids, or any combination thereof.

In some embodiments, the DTM system herein integrates machine learning models in a specialized AI-driven server management chipset and located near the Baseboard Management Controller (BMC) of the chipset, facilitating proactive cooling adjustments. The specialized AI-driven server management chipset may be a Trusted Control/Compute Unit (TCU) with a plurality of programmable AI engines to implement the AI algorithms herein for accelerated computation. Combining real-time monitoring, dynamic adjustments, predictive AI modeling, and strategic integration, the DTM systems herein offer a comprehensive solution to optimize data center cooling efficiency and sustainability.

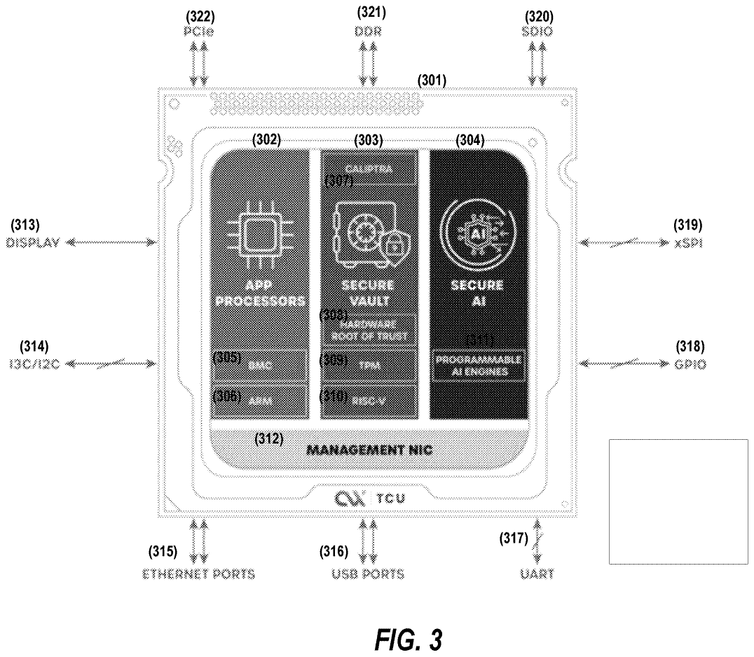

In some embodiments, the system may integrate the predictive AI model into a specialized AI-driven server management chipset such as Trusted Control/Compute Unit (TCU) illustrated in FIG. 3. The TCU may be a purpose-built, fully integrated AI-driven hardware security platform.

In some embodiments, the TCU 300 can comprise a chipset 301. In some embodiments, the TCU 300 can comprise one or more processors 302. In some cases, the one or more processors of the TCU 300 can comprise application processors 302. In some cases, the application processors 302 of the TCU 300 can comprise a Baseboard Management Controller (BMC) 305, or an ARM processor 306, or both. The BMC may monitor and manage servers remotely, even when the server's primary operating system is not functioning. The BMCs may continuously monitor various hardware components such as temperature sensors, fan speeds, power supplies, and voltage levels, providing real-time information about the server's overall health and status.

The TCU may integrate with programmable AI engines 311 implementing the predictive AI model herein for generating cooling system control commands (e.g., fan speed). By integrating the predictive AI model into the same chipset where the Baseboard Management Controller (BMC) 305 is located, the AI model may receive the real-time sensor data (indicative of workload and real-time system state) directly from the BMC as input and make cooling system inference based on the incoming workload data This beneficially reduces the memory storage requirement and reduces transmission and processing delay.

In some embodiments, the one or more processors 302 of the TCU 300 can be configured to generate one or more security protocols 303. In some embodiments, the one or more security protocols can comprise one or more of: Secure Network Interface Controller (Secure-NIC) protocols, hardware Root of Trust (HROT) protocols 308, Trusted Platform Module (TPM) protocols 309, RISC-V (310), or any combination thereof. In some embodiments, the one or more security protocols can be managed by a security manager module of the TCU 300, such as a management network interface controller (NIC) 312. In some cases, the HROT protocols 308 can comprise a Caliptra protocol 307. In some embodiments, the one or more security protocols can be configured to bypass one or more processors of the cooling system.

In some embodiments, the computing unit, or the cooling system, or both, can comprise one or more sensors. In some embodiments, the TCU 300 can be further configured to retrieve data from one or more sensors. In some embodiments, the one or more sensors can be related to the computing unit. In some embodiments, the one or more sensors can be related to the one or more cooling elements of the cooling system. In some embodiments, the one or more sensors can be related to both the computing unit and the one or more cooling elements of the cooling system. In some embodiments, the TCU 300 can receive input from the one or more sensors using one or more of: an Improved Inter-Integrated Circuit (I3C/IC2) 315, ethernet ports 315, USB ports 316, a Universal Asynchronous Receiver/Transmitter 317, a General Purpose Input/Output Chip 318, an expanded serial peripheral interface (xSPI) 319, a Secure Digital Input/Output Controller 320, Double Data Rate (DDR) chips 321, or a PCIe interface chip 322, or any combination thereof.

In some embodiments, the TCU 300 can be further configured to retrieve data from the one or more sensors of the computing unit, or the one or more sensors of the cooling system, or both. In some embodiments, the one or more sensors can comprise one or more of: a temperature sensor, a network traffic sensor, an energy consumption sensor, or an operational sensor, or any combination thereof. In some embodiments, the one or more sensors can comprise one or more of: temperature sensors, network traffic sensors, energy consumption sensors, or operational sensors, or any combination thereof. In some embodiments, the operational sensor can comprise one or more of: a movement sensor, a rotation sensor, a liquid flow sensor, or a signaling sensor, or any combination thereof. In some embodiments, the operational sensors comprise one or more of: movement sensors, rotation sensors, liquid flow sensors, power sensors, voltage sensors, or signaling sensors, or any combination thereof.

In some embodiments, the TCU 300 can further comprise one or more artificial intelligence/machine learning engines 311. In some embodiments, the TCU 300 may comprise secure AI engines 311. In some embodiments, the TCU 300 may comprise a plurality of programmable AI engines 311 for accelerating machine learning models. In some embodiments, the one or more artificial intelligence/machine learning engines (AI/ML) 311 can be configured to accelerate processing of the one or more artificial intelligence/machine learning (AI/ML) models, such as deep reinforcement learning models (DRL models). In some embodiments, the one or more artificial intelligence/machine learning engines 311 can be configured to accelerate processing of the deep reinforcement learning model. In some embodiments, the TCU 300 can be configured to comprise four AI/ML engines 311. In some embodiments, the TCU 400 can comprise one, two, three, four, five, six, seven, eight, nine, ten, or more than ten AI/ML engines 311.

In some embodiments, the one or more programmable AI engines 311 may be a collection of vector processors that are designed to perform AI inference and signal processing such as making inference for controlling the fan speed of the cooling system. In some cases, the one or more programmable AI engines be customized and configured through software to make inferences, allowing users to tailor its functionality to different applications (e.g., different cooling systems, etc.) by adjusting algorithms and parameters based on their specific needs, often utilizing a combination of hardware acceleration and software programming to optimize performance for various AI workloads.

In some embodiments, the TCU 300 may provide capabilities comprising outputting information to a display model 313 such as via a display port.

In some embodiments, the system can further comprise a Baseboard Management Controller (BMC). In some embodiments, the deep reinforcement learning model can receive input from the BMC. In some embodiments, the BMC can comprise a Graphic User Interface (GUI). In some embodiments, the BMC can be configured to display to a user the cooling plan. In some embodiments, the BMC can be configured to display to a user the cooling plan via the GUI. In some embodiments, the GUI can comprise a cooling plan GUI configured to display to the user the cooling plan. In some embodiments, the BMC can be further configured to display to the user data from the one or more sensors. In some embodiments, the BMC can be further configured to display to the user data from the one or more sensors via the GUI. In some embodiments, the BMC can be configured to facilitate adjustments to the cooling plan by the user. In some embodiments, the BMC can be further configured to display to the user one or more operational parameters of the cooling system via the GUI. In some embodiments, the BMC can be configured to facilitate modification of the cooling plan by the user. In some cases, changes to the cooling plan made by the user can modify the cooling plan GUI. In some cases, the user can modify the cooling plan by touchscreen, cursor interaction, keystroke, touchpad, or other activation method.

In some embodiments, the at least one processor can be further configured to modify the command for adjusting an operation parameter of the cooling system based at least in part on the modification to the cooling plan by the user. In some embodiments, the at least one processor can be further configured to modify the cooling plan based at least in part on the adjustments to the cooling plan by the user. In some embodiments, the deep reinforcement learning model can be trained utilizing feedback input can comprise the modification to the cooling plan by the user. In some embodiments, the one or more artificial intelligence/machine learning (AI/ML) models, such as deep reinforcement learning models (DRL models) can be trained utilizing feedback data. In some cases, the feedback data can comprise the adjustments to the cooling plan by the user. In some embodiments, the deep reinforcement learning model can be trained utilizing feedback input data retrieved from the one or more sensors. In some embodiments, the one or more artificial intelligence/machine learning (AI/ML) models, such as deep reinforcement learning models (DRL models) can be trained utilizing feedback data. In some embodiments, the AI/ML models such as DRL models can be trained utilizing data from the one or more sensors. In some embodiments, the data from the one or more sensors can be associated with the adjustment of the one or more cooling elements of the cooling system. In some cases, the AI/ML models such as DRL models can be trained utilizing modified data from the one or more sensors.

In some embodiments, the data retrieved from the one or more sensors can be generated by the one or more sensors subsequently to adjusting the operation parameter of the cooling system. In some embodiments, the deep reinforcement learning model can be further configured to generate an energy efficiency score of the cooling system. In some embodiments, the at least one processor can be further configured to perform operations comprising scoring energy efficiency of the cooling system. In some embodiments, the deep reinforcement learning model can generate the energy efficiency score of the cooling system based at least in part on energy consumption of the cooling system and energy consumption of the computing unit. In some embodiments, the energy efficiency of the cooling system can be scored based at least in part on energy consumption of the cooling system. In some embodiments, the deep reinforcement learning model can be further configured to generate a modified cooling plan based at least in part on the energy efficiency score of the cooling system. In some embodiments, the energy efficiency of the cooling system can be scored based at least in part on energy consumption of the computing unit. In some embodiments, the deep reinforcement learning model can be trained utilizing the energy efficiency score of the cooling system. In some embodiments, the energy efficiency of the cooling system can be scored based at least in part on both energy consumption of the cooling system and energy consumption of the computing unit. In some embodiments, the energy efficiency of the cooling system can be scored as a power usage effectiveness (PUE) value. In some cases, the PUE value can comprise a score indicating how efficiently a data center uses energy. In some cases, the PUE score comprises a division of the total energy consumed by the data center by the total energy consumed by all of the computing unit, as shown in Equation 1 below.

$$PUE = \frac{Total Facility Energy}{Hardware Unit Energy} = \frac{\begin{matrix}Total Facility Energy ( with Hardware \\ Unit fan energy included )\end{matrix}}{Hardware Unit Energy + Hardware Unit Fan Energy} . \qquad Equation 1$$

In some embodiments, the PUE score can be calculated to score power savings of the computing unit, shown in Equation 2 below.

$${PUE}_{Power Savings} = \frac{\begin{matrix}Total Facility Energy ( with Hardware Unit \\ fan energy included )\end{matrix}}{Hardware Unit Computation Energy} . \qquad Equation 2$$

In some embodiments, the at least one processor can be further configured to modify the cooling plan. In some embodiments, the at least one processor can be further configured to modify the cooling plan based at least in part on the energy efficiency score of the cooling system. In some embodiments, the at least one processor can be further configured to modify the cooling plan based at least in part on the PUE score of the cooling system. In some cases, modifying the cooling plan comprises modifying the planned allocation of energy between the one or more cooling elements of the cooling system. In some cases, modifying the cooling plan can comprise modifying the amount of power allocated to one or more cooling elements of the cooling system. In some cases, modifying the cooling plan can comprise modifying the duration of operation or non-operation of one or more elements of the cooling system. In some embodiments, the one or more artificial intelligence/machine learning (AI/ML) models, such as deep reinforcement learning models (DRL models) can be trained utilizing the energy efficiency score of the cooling system. In some cases, the one or more AI/ML models can be trained utilizing the PUE score of the system.

In some cases, the DRL models can be configured to evaluate reliability and stability of the cooling system performance. In some cases, the cooling plan can be modified based on reliability data or stability data of the cooling system. In some cases, the reliability data or stability data can comprise one or more of: frequency of thermal throttling data, hardware stress data, system uptime data, or system downtime data, or any combination thereof.

In some embodiments, the one or more processors of the system can be further configured to communicate with the cooling system over a network. In some embodiments, the one or more processors of the system can be further configured to communicate with the one or more elements of the cooling system over a network. In some cases, the network can comprise a secure network. In some embodiments, the network can comprise a remote network. In some embodiments, the network can comprise a cloud network. In some embodiments, communication with the cooling system can comprise the one or more processors of the system instructing the cooling system, or one or more elements thereof, to modify the operation or planned allocation of energy to the one or more elements of the cooling system.

In some embodiments, the one or more sensors can output data resulting from the modification of the one or more elements of the cooling system. In some embodiments, the sensor data resulting from the modification of the one or more elements of the cooling system can comprise feedback data. In some cases, the feedback data can be received by the AI/ML models such as DRL models. In some embodiments, the AI/ML models such as DRL models can modify the cooling plan based at least in part on the feedback data.

In some embodiments, the system can be scalable. In some embodiments, the system can be configured to address a larger number of computer units, such as a large number of servers. In some embodiments, the system can be configured to address a small number of computer units, such as a small number of servers. In some cases, the system can be configured to communicate with a large cooling system. In some cases, the system can be configured to communicate with a small cooling system.

In some embodiments, the system can be configured to modify the cooling plan or adjust an operation parameter of a cooling system based at least in part on the characteristics of the environment surrounding the computing units, or the cooling system, or both. In some cases, the characteristics of the environment can comprise one or more of: temperature of the environment, humidity of the environment, size of the environment, unfilled space of the environment, ceiling height of the environment, outdoor conditions of the environment, season of the environment, location of the environment, airflow of the environment, or any combination thereof.

In some embodiments, the system can generate a digital twin model. The digital twin can comprise a replica of one or more elements of the system, such as the processors, the DRL model, the computing unit, or the cooling system. In some cases, the digital twin model can replicate the conditions of the environment, such as temperature of the environment, humidity of the environment, size of the environment, unfilled space of the environment, ceiling height of the environment, outdoor conditions of the environment, season of the environment, location of the environment, airflow of the environment, or any combination thereof. In some cases, the digital twin model can be utilized to simulate a cooling plan or adjustment to cooling unit operations in situ. In some cases, the DRL model can receive feedback data associated with the digital twin model. This feedback data can comprise predicted sensor data, predicted temperature conditions, or predicted efficiency scores in situ of digital twin model simulations. The digital twin model simulations can comprise thermodynamic simulations. The digital twin model can utilize in situ characteristic parameters for simulations, such as rack positions, air flow patterns, climate conditions, seasonal variations, load peaks, load troughs, temperature of the environment, humidity of the environment, size of the environment, unfilled space of the environment, ceiling height of the environment, outdoor conditions of the environment, season of the environment, location of the environment, simulated performance characteristics such as simulated amount of queries, CPU usage, memory usage, disk input and output (disk I/O) operations, network traffic, server performance counters, or request rates, or any combination thereof. In some embodiments, real-time data such as sensor data can be integrated into the digital twin model. In some cases, real-time temperature data, real-time operational data, real-time environment data, or real-time sensor data can be integrated into the digital twin model. In some cases, high-fidelity modeling can be utilized to generate the digital twin model. In some cases, the digital twin model can utilize fluid dynamics and thermodynamics equations for generating simulations in situ. In some cases, the cooling system design generated by the digital twin model can be utilized to optimize the system.

In some cases, the system can further comprise generating an alert. In some cases, the alert can be generated when data outside normal parameters from one or more sensors has been received. In some cases, the data received from one or more sensors can be above or below a threshold. In some cases, upon receiving temperature data or operational data from one or more sensors that is above a predetermined threshold, the DRL model can generate an indication. In some cases, the indication can be an indication of one or more hardware components of a computing unit overheating, or overperforming, or both. In some cases, the indication can comprise an indication that one or more sensors detect a temperature above or below a predetermined threshold. In some cases, the indication can comprise an indication that one or more sensors detect an operational parameter above or below a predetermined threshold. In some cases, the indication can be generated by the DRL model. In some cases, the indication can be output to a user, such as using a GUI of the BMC. In some embodiments, the DRL model can estimate that one or more sensors or one or more hardware components of a computing unit associated with one or more sensors may exceed a threshold. In some cases, the DRL model can output a customized message to a user based on the indication. In some cases, the indication can comprise an automatic action, such as the reduction or stoppage of power to one or more computing units.

In some cases, the system can further comprise a Power Management Unit (PMU). In some cases, the PMU can be configured to receive input from the BMC. In some cases, the PMU can be communicatively coupled to the BMC. In some cases, the BMC can provide instructions to dynamically adjust the settings of the PMU. In some cases, the DRL model can be configured to output a command for adjusting one or more settings of the PMU. In some cases, the DRL model can be configured to predict modified settings of the PMU. In some cases, the BMC can instruct the PMU to apply the predicted modified settings. In some cases, the settings of the PMU control power consumption of one or more hardware components of the computing unit. In some cases, the power consumption of one or more computing units can be modified by the PMU settings. In some cases, the PMU settings can be modified based at least in part on one or more conditions of the system, such as temperature, operational capacity, or failure.

In some cases, the DRL model can be configured to predict a future failure of one or more hardware components or one or more computing units. In some cases, the prediction can be based on real-time operational feedback data, sensor feedback data, or real-time temperature data, or any combination thereof. In some cases, the BMC can modify one or more settings of the PMU based at least in part on the prediction of failure by the DRL model. In some cases, the PMU settings can be modified to reduce power supply to one or more hardware components or one or more computing units. In some cases, the system can be configured to initiate or modify network communications with a cloud system, such as to save data as a backup. In some cases, the system can be modified to avoid an interruption based at least in part on the DRL model prediction of failure of the computing unit, the cooling system, or both.

In some cases, the DRL model can be configured to detect or predict anomalies in performance based on data from one or more sensors. In some cases, the DRL model can perform validation of sensor data, calibration of sensor data, or both. In some embodiments, data received by the BMC from one or more sensors at a time point can be compared to data received by the BMC form the respective one or more sensors at one or more additional time points. In some embodiments, data received by the BMC from one or more sensors at one or more time points can be compared to an average value of the respective data. In some cases, the DRL model can compare sensor data at one or more time points to determine of real-time sensor data, or stored sensor data at one or more time points, is faulty data. In some cases, the DRL model can determine whether multiple data points from a sensor indicate that the sensor is malfunctioning. In some cases, the system can generate an indication of sensor malfunction. In some cases, the system can generate an indication to a user of sensor malfunction of one or more sensors.

In some cases, the DRL model can be configured to predict a maintenance event for one or more hardware components of a computing unit, or one or more cooling components of a cooling system, or both. In some cases, the DRL model can predict a maintenance event based on data anomalies associated with one or more sensors of the one or more hardware components of a computing unit, or one or more sensors of one or more cooling components of the cooling system, or both. In some cases, the DRL model can be configured to generate an indication that maintenance should be performed on the one or more hardware components of a computing unit, or one or more cooling components of the cooling system, or both, based on the predicted maintenance event. In some cases, the DRL model can be configured to generate an indication that maintenance should be performed on one or more sensors based at least in part on the predicted maintenance event. In some cases, the DRL model can provide a prediction that maintenance is recommended for one or more hardware components of a computing unit or one or more cooling components of the cooling system, or both, based at least in part on comparing real-time data with stored data. In some cases, the DRL model can generate a maintenance prediction based on a pattern of changes of temperature data or operational data over time. In some cases, the DRL model can be configured to generate a maintenance recommendation based on the maintenance prediction. In some cases, the DRL model can be configured to generate an indication, such as a communication to a user, of a recommended action based on anomalous sensor data. In some cases, the DRL model can receive as feedback data associated with performance of a maintenance, real-time data before performance of maintenance occurs, or real-time data after performance of maintenance occurs, or any combination thereof.

In some embodiments, the system can further comprise an LLM. In some embodiments, the LLM can be communicatively coupled to the BMC. In some embodiments, the LLM can be used to enhance security of the system. In some cases, the LLM can be configured to identify deviations from standard procedures in a software update to the system, for example a firmware update. In some cases, the LLM can be configured to detect unfamiliar boot sequences. In some cases, the LLM can be configured to provide an indication that a boot sequence is an unfamiliar boot sequence. In some cases, the LLM can be configured to detect irregular API interactions. In some cases, the LLM can receive input data comprising requests, code, or communications received by the system. In some cases, the LLM can indicate detection of irregular or unfamiliar sequences, interactions, requests, code, or communications to the BMC. In some cases, the BMC can be configured to send one or more commands to the system based on receiving input comprising an LLM output indication. In some cases, these one or more commands to the system can comprise instructions to initiate one or more security components. In some cases, these one or more commands to the system can comprise instructions to shut down power to one or more components of the system, disconnect from a network, block a request, stop an output of the system, or any combination thereof.

In some embodiments, the LLM can be configured to receive as input one or more natural language commands from the BMC. In some cases, the natural language commands can be input by a user at a GUI of the BMC. In some cases, the LLM can be configured to generate one or more executable actions based on the natural language commands, which can be output to the BMC. In some cases, the LLM can be configured to analyze temperature and performance data from the BMC based at least in part on the natural language commands. In some cases, the LLM can be configured to generate one or more indications or alerts to a user based at least in part on the analysis of temperature and performance data.

In some embodiments, the LLM can comprise a large sensor model. In some cases, the large sensor model can receive input data from a plurality of sensors comprising multiple sensor types. In some cases, the multiple sensor types can comprise temperature sensors, humidity sensors, operational sensors, energy consumption sensors, airflow sensors, or any combination thereof. In some cases, the large sensor model comprising the LLM can comprise transformer architecture adapted from LLM architecture. In some embodiments, the input data from the plurality of sensors can comprise one or more multi-sensor data streams. In some embodiments, the large sensor model comprising the LLM can be configured to interface with the cooling system. In some cases, the large sensor model comprising the LLM can be configured to generate one or more temperature predictions. In some cases, the temperature event predictions can include overheating events or thermal trends, or both. In some embodiments, the large sensor model comprising the LLM can be configured to generate one or more operational commands based at least in part on the temperature predictions. In some cases, the generated one or more operational commands can be communicated to the cooling system. In some embodiments, the large sensor model comprising the LLM can be trained prior to receiving data from the plurality of sensors comprising multiple sensor types. In some cases, the large sensor model comprising the LLM can be trained prior to receiving data from the plurality of sensors comprising multiple sensor types. In some cases, the large sensor model comprising the LLM can be trained prior to generating the one or more operational commands. In some cases, the large sensor model comprising the LLM can be trained prior to communicating the one or more operational commands to the cooling system.

### Methods for Dynamic Cooling of Computing Unit

In yet another aspect of the present disclosure, described herein is a method for dynamic thermal management, the method can comprise (a) receiving real-time data related to one or more hardware components of a computing unit, wherein the real-time data can comprise at least CPU data or memory usage indicative of an incoming workload of the computing unit; and (b) feeding the real-time data as input to a deep reinforcement learning model, and outputting a command for adjusting an operation parameter of a cooling system for the computing unit.

Described herein in yet another aspect of the present disclosure is a method for dynamic cooling of computing unit. In some embodiments, the method can comprise associating temperature data. In some cases, the real-time temperature data can pertain to the computing unit. In some embodiments, the method can further comprise determining a workload for the computing unit. In some embodiments, the method can further comprise generating a cooling plan. In some embodiments, the cooling plan can be generated for the computing unit based at least in part on the associated with hardware temperature data. In some embodiments, the cooling plan can be generated for the computing unit based at least in part on the determined workload. In some embodiments, the cooling plan can be generated for the computing unit based at least in part on both the associated with hardware temperature data and the determined workload. In some embodiments, the method can further comprise communicating with a cooling system. In some embodiments, the method can further comprise communicating with a cooling system to adjust one or more cooling elements of the cooling system based at least in part on the generated cooling plan.

Another aspect of the present disclosure provides a non-transitory computer readable medium comprising machine executable code that, upon execution by one or more computer processors, can implement any of the methods or operations above or elsewhere herein.

Additional aspects and advantages of the present disclosure will become readily apparent to those skilled in this art from the following detailed description, wherein only illustrative embodiments of the present disclosure are shown and described. As will be realized, the present disclosure is capable of other and different embodiments, and its several details are capable of modifications in various obvious respects, all without departing from the disclosure. Accordingly, the drawings and description are to be regarded as illustrative in nature, and not as restrictive.

### EXAMPLES

The following examples are provided to further illustrate some embodiments of the present disclosure, but are not intended to limit the scope of the disclosure; it will be understood by their exemplary nature that other procedures, methodologies, or techniques may alternatively be used.

### Example 1: Data Efficiency of AI/ML Model Integration into Cooling Systems

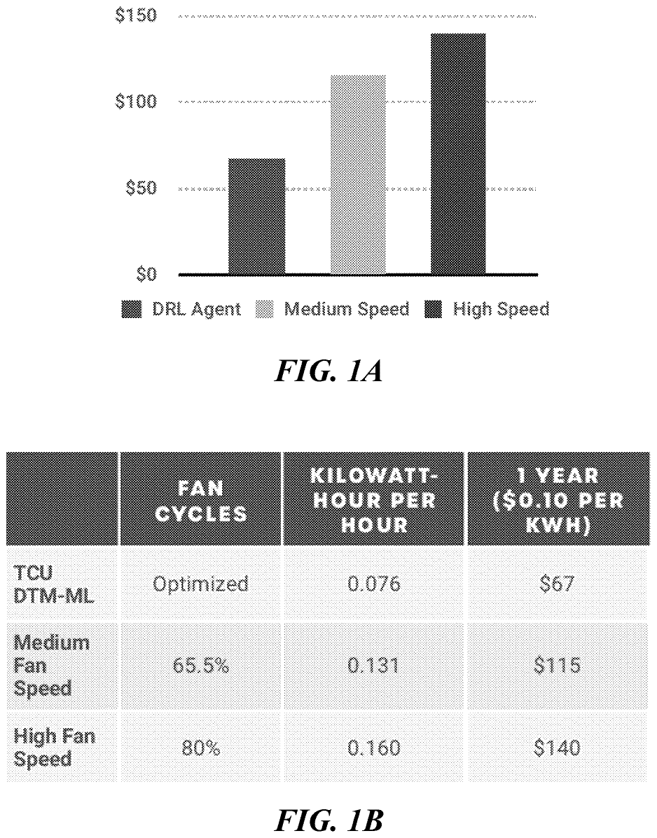

As illustrated in FIG. 1A, the energy costs over one year for three different cooling system implementations were obtained. The compared cooling system implementations were a cooling system with a Deep Reinforcement Learning (DRL) model integrated, a medium speed fan cooling system, and a high-speed fan cooling system.

As illustrated in FIG. 1B, an optimization value was calculated for the fan cycle of the three groups, in addition to kilowatt-hour per hour and the power cost for one year for each group. The compared cooling system implementations were a cooling system with a Deep Reinforcement Learning (DRL) model integrated, a medium speed fan cooling system, and a high-speed fan cooling system.

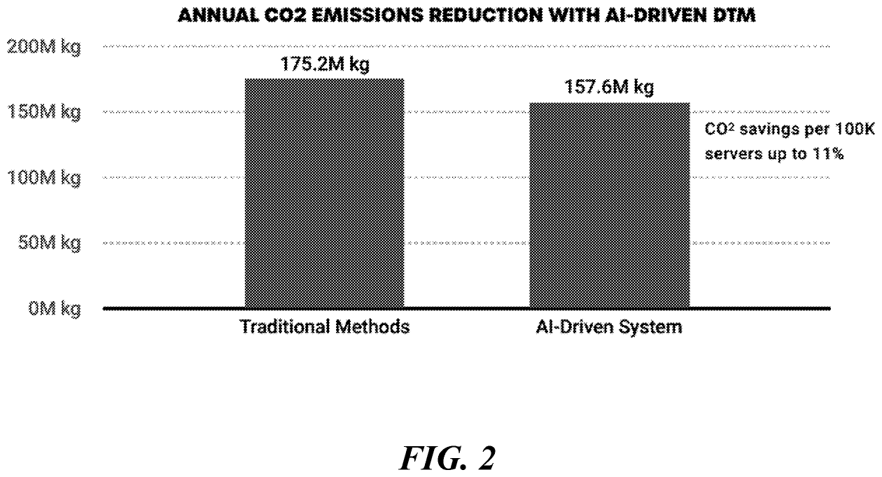

As shown in FIG. 2, for example, carbon dioxide (CO₂) emissions were calculated and charted in kg for a traditional cooling method group and an AI-Driven cooling System group.

An exemplary Trusted Control/Compute Unit (TCU) is illustrated in FIG. 3, previously discussed herein.

### Example 2: Exemplary Methods of Cooling System Management

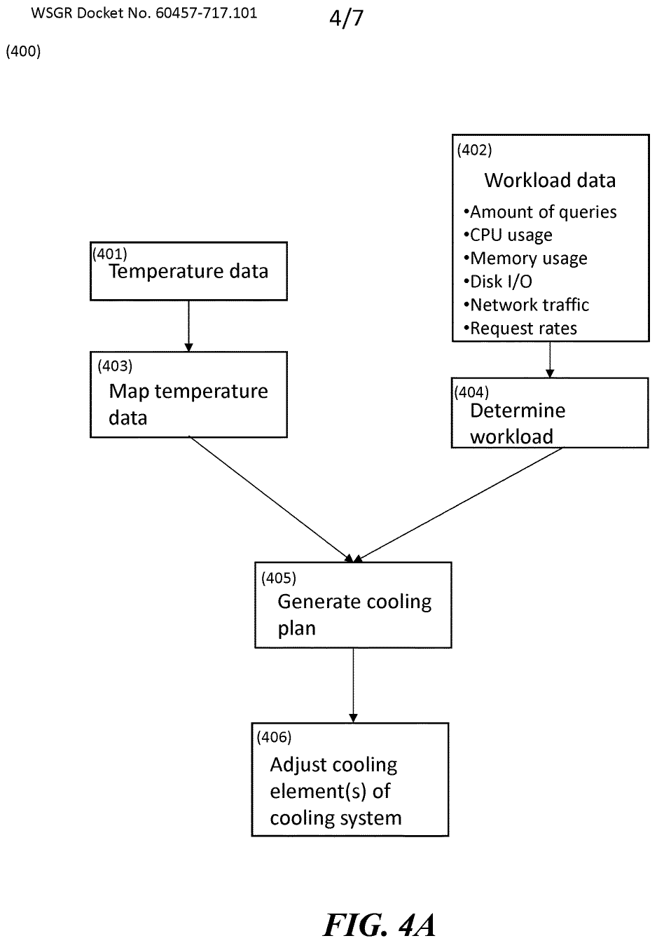

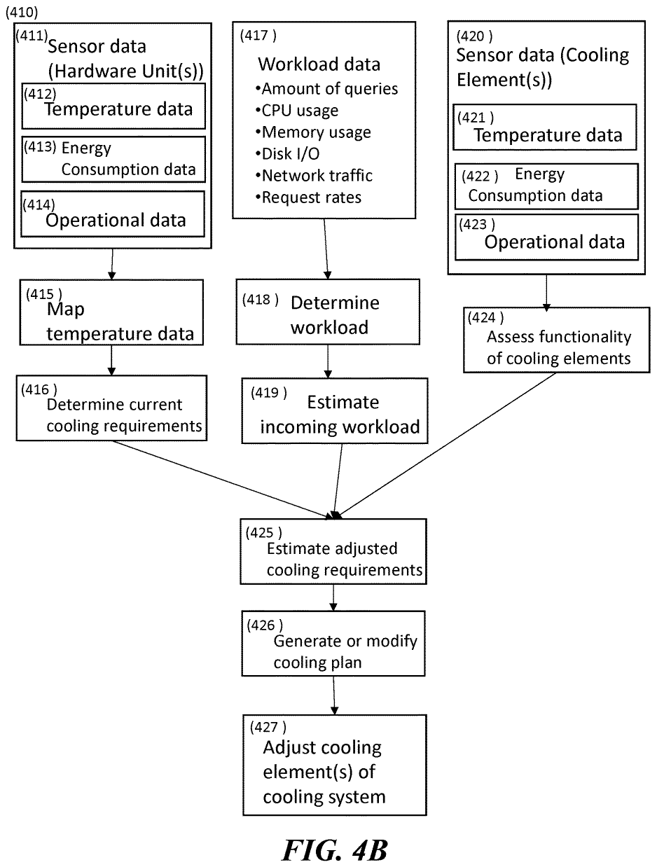

An exemplary workflow for cooling system management 400 is shown in FIG. 4A. The method 400 includes, for example, temperature data input 401 and associating map temperature data 403. In parallel, previously, or after associating temperature data 403, the method 400 includes receiving workload data 402 as input. As illustrated in, for example FIG. 4A, exemplary types of workload data 402 can include amount of queries, CPU usage data, memory usage data, disk I/O data, network traffic data, request rates, or any combination thereof. In the exemplary method, workload can be determined 404 from the incoming workload data 402. Then, for example from the map temperature data 403 associated with temperature data 401, and the determined workload 404, a cooling plan 405 can be generated. The last step, for example, can be to adjust one or more cooling elements 406 of the cooling system in the exemplary method workflow 400.

An additional exemplary method 410 embodiment is illustrated in FIG. 4B. For example, sensor data 411 from computing unit can be input. Sensor data related to the computing unit 411 can include, for example, temperature data 412, energy consumption data 413, and/or operational data 414, or any combination thereof relating to the computing unit. Workload data 417 can also be received as input, for example. As illustrated in, for example FIG. 4B, exemplary types of workload data 417 can include amount of queries, CPU usage data, memory usage data, disk I/O data, network traffic data, request rates, or any combination thereof. Additionally, sensor data related to the one or more cooling elements 420 can also be received as input, for example. Sensor data related to the one or more cooling elements 420 can include, for example, temperature data 421, energy consumption data 422, and/or operational data 423, or any combination thereof relating to the one or more cooling elements.

From the sensor data relating to the computing unit 411, for example, as illustrated in FIG. 4B, temperature data can be mapped 415 associated with the cooling unit. Then, for example, real-time cooling requirements 416 can be determined using, for example, the mapped temperature data 415. From the incoming workload data 417 for example, workload 418 can be determined. Then, for example, incoming workload 419 can be predicted using the determined workload 418. From the sensor data relating to the one or more cooling elements 420, for example, functionality of cooling elements can be assessed 424.

Then, any one or more of: the determined real-time cooling requirements 416, the predicted incoming workload 419, and the assessed functionality of cooling elements 424, can be used in the next step. The next step can be to predict adjusted cooling requirements 425 as shown in FIG. 4B. Next, for example, the cooling plan can be generated or modified 426. As a last step in the exemplary method 410, for example, the cooling elements of the cooling system can be adjusted 427.

### Example 3: Exemplary Systems for Cooling System Management

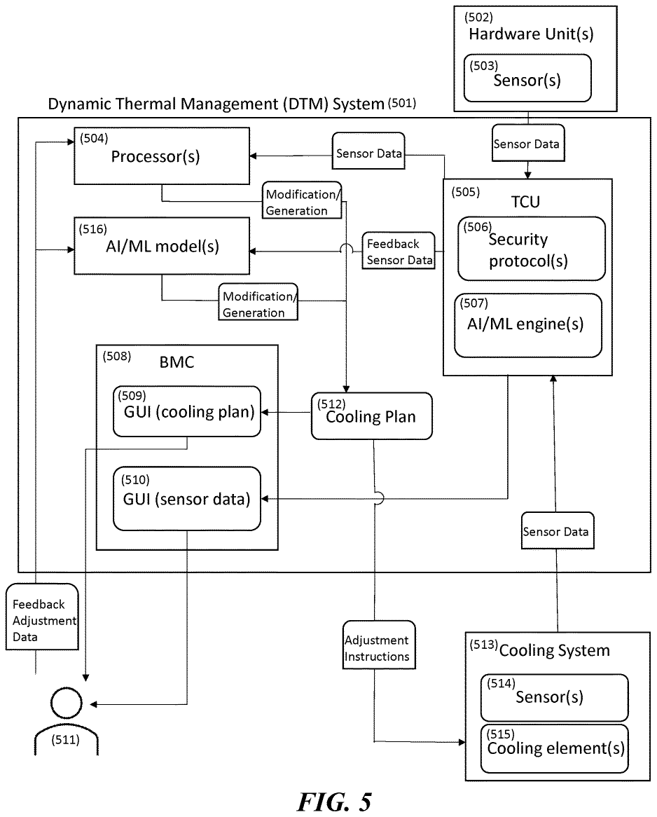

An exemplary architecture diagram 500 for a Dynamic Thermal Management (DTM) System 501 is illustrated in FIG. 5. For example, the computing unit 502 can include one or more sensors 503. The computing unit 503 can output sensor data from the one or more sensors 503 to the Trusted Control/Compute Unit (TCU) 505, which receives the sensor data as input. As illustrated in FIG. 5, for example, the TCU 505 can include one or more security protocols 506 and one or more AI/ML engines 507. For example, the TCU 505 can output sensor data to the one or more processors 504 of the system. The one or more processors 504 can, for example, generate a cooling plan 512. The cooling plan 512 can, for example, be received by the Baseboard Management Controller (BMC) 508. The BMC 508 can include, for example, multiple graphic user interfaces (GUIs). One GUI of the BMC 508 can be a cooling plan GUI 509. Another GUI of the BMC 508 can be a sensor data GUI 510. The sensor data GUI 510 can be received by the BMC 508 from the TCU 505. For example, the cooling plan GUI 509 or the sensor data GUI 510, or both, can be output by the DTM System 501 to a user 511. The user 511 can, for example, input feedback adjustment data to the one or more processors 504 or one or more AI/ML models 516.

As illustrated in FIG. 5, for example, the one or more processors 504 or the one or more AI/ML models 516, or both, can utilize the feedback adjustment data to output modifications or generations of the cooling plan 512. The cooling plan can again be received by the BMC 508, or the cooling plan can be output by the DTM System 501 as adjustment instructions to the cooling system 513. For example, the cooling system 513 can include one or more sensors 514 and one or more cooling elements 515. For example, the cooling system 513 can output sensor data from the cooling system sensors 514 to the TCU 505.

As illustrated, for example, in FIG. 5, the TCU 505 can output feedback sensor data to the one or more AI/ML models 505. The one or more AI/ML models 516 can then modify or generate the cooling plan 512 based on the feedback sensor data. For example, the cooling plan 512 can then be output by the DTM system 501 as adjustment instructions to the cooling system 513 in a feedback loop.

### Computing Systems

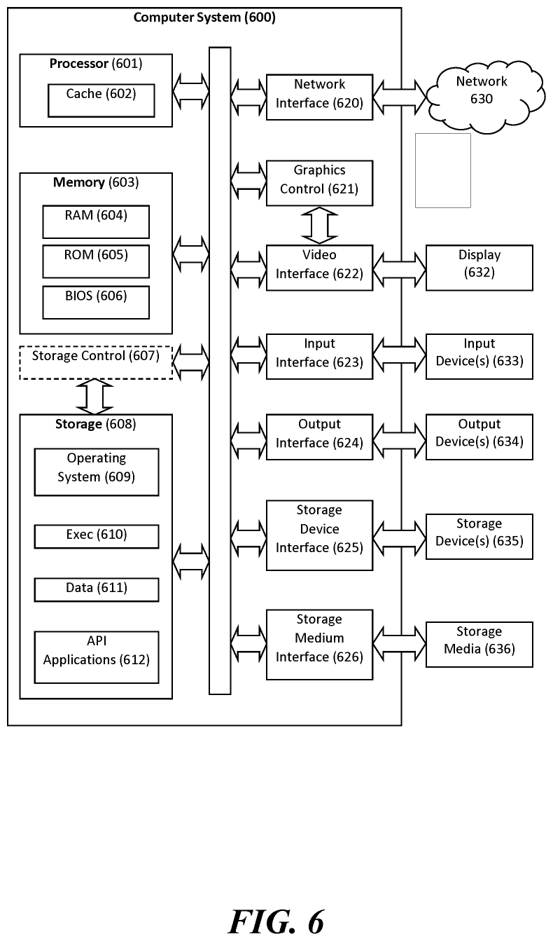

Referring to FIG. 6, a block diagram is shown depicting an exemplary machine that includes a computer system 600 (e.g., a processing or computing system) within which a set of instructions can execute for causing a device to perform or execute any one or more of the aspects and/or methodologies for static code scheduling of the present disclosure. The components in FIG. 6 are examples only and do not limit the scope of use or functionality of any hardware, software, embedded logic component, or a combination of two or more such components implementing particular embodiments.

Computer system 600 may include one or more processors 601, a memory 603, and a storage 607 that communicate with each other, and with other components, via a bus 640. The bus 640 may also link a display 632, one or more input devices 633 (which may, for example, include a keypad, a keyboard, a mouse, a stylus, etc.), one or more output devices 634, one or more storage devices 635, and various tangible storage media 636. All of these elements may interface directly or via one or more interfaces or adaptors to the bus 640. For instance, the various tangible storage media 636 can interface with the bus 640 via storage medium interface 626. Computer system 600 may have any suitable physical form, including but not limited to one or more integrated circuits (ICs), printed circuit boards (PCBs), mobile handheld devices (such as mobile telephones or PDAs), laptop or notebook computers, distributed computer systems, computing grids, or servers.

Computer system 600 includes one or more processor(s) 601 (e.g., central processing units (CPUs) or general-purpose graphics processing units (GPGPUs)) that carry out functions. Processor(s) 601 optionally contains a cache memory unit 602 for temporary local storage of instructions, data, or computer addresses. Processor(s) 601 are configured to assist in execution of computer readable instructions. Computer system 600 may provide functionality for the components depicted in FIG. 6 as a result of the processor(s) 601 executing non-transitory, processor-executable instructions embodied in one or more tangible computer-readable storage media, such as memory 603, storage 608, storage devices 635, and/or storage medium 636. The computer-readable media may store software that implements particular embodiments, and processor(s) 601 may execute the software. Memory 603 may read the software from one or more other computer-readable media (such as mass storage device(s) 635, 636) or from one or more other sources through a suitable interface, such as network interface 620. The software may cause processor(s) 601 to carry out one or more processes or one or more operations of one or more processes described or illustrated herein. Carrying out such processes or operations may include defining data structures stored in memory 603 and modifying the data structures as directed by the software.

The memory 603 may include various components (e.g., machine readable media) including, but not limited to, a random access memory component (e.g., RAM 604) (e.g., static RAM (SRAM), dynamic RAM (DRAM), ferroelectric random access memory (FRAM), phase-change random access memory (PRAM), etc.), a read-only memory component (e.g., ROM 605), and any combinations thereof. ROM 605 may act to communicate data and instructions unidirectionally to processor(s) 601, and RAM 604 may act to communicate data and instructions bidirectionally with processor(s) 601. ROM 605 and RAM 604 may include any suitable tangible computer-readable media described below. In one example, a basic input/output system 606 (BIOS), including basic routines that help to transfer information between elements within computer system 600, such as during start-up, may be stored in the memory 603.

Fixed storage 608 is connected bidirectionally to processor(s) 601, optionally through storage control unit 607. Fixed storage 607 provides additional data storage capacity and may also include any suitable tangible computer-readable media described herein. Storage 608 may be used to store operating system 609, executable(s) 610, data 611, applications 612 (application programs), and the like. Storage 608 can also include an optical disk drive, a solid-state memory device (e.g., flash-based systems), or a combination of any of the above. Information in storage 608 may, in appropriate cases, be incorporated as virtual memory in memory 603.

In one example, storage device(s) 635 may be removably interfaced with computer system 600 (e.g., via an external port connector (not shown)) via a storage device interface 625. Particularly, storage device(s) 635 and an associated machine-readable medium may provide non-volatile and/or volatile storage of machine-readable instructions, data structures, program modules, and/or other data for the computer system 600. In one example, software may reside, completely or partially, within a machine-readable medium on storage device(s) 635. In another example, software may reside, completely or partially, within processor(s) 601.

Bus 640 connects a wide variety of subsystems. Herein, reference to a bus may encompass one or more digital signal lines serving a common function, where appropriate. Bus 640 may be any of several types of bus structures including, but not limited to, a memory bus, a memory controller, a peripheral bus, a local bus, and any combinations thereof, using any of a variety of bus architectures. As an example and not by way of limitation, such architectures include an Industry Standard Architecture (ISA) bus, an Enhanced ISA (EISA) bus, a Micro Channel Architecture (MCA) bus, a Video Electronics Standards Association local bus (VLB), a Peripheral Component Interconnect (PCI) bus, a PCI-Express (PCI-X) bus, an Accelerated Graphics Port (AGP) bus, HyperTransport (HTX) bus, serial advanced technology attachment (SATA) bus, and any combinations thereof.

Computer system 600 may also include an input device 633. In one example, a user of computer system 600 may enter commands and/or other information into computer system 600 via input device(s) 633. Examples of an input device(s) 633 include, but are not limited to, an alpha-numeric input device (e.g., a keyboard), a pointing device (e.g., a mouse or touchpad), a touchpad, a touch screen, a multi-touch screen, a joystick, a stylus, a gamepad, an audio input device (e.g., a microphone, a voice response system, etc.), an optical scanner, a video or still image capture device (e.g., a camera), and any combinations thereof. In some embodiments, the input device is a Kinect, Leap Motion, or the like. Input device(s) 633 may be interfaced to bus 640 via any of a variety of input interfaces 623 (e.g., input interface 623) including, but not limited to, serial, parallel, game port, USB, FIREWIRE, THUNDERBOLT, or any combination of the above.

In particular embodiments, when computer system 600 is connected to network 630, computer system 600 may communicate with other devices, specifically mobile devices and enterprise systems, distributed computing systems, cloud storage systems, cloud computing systems, and the like, connected to network 630. Communications to and from computer system 600 may be sent through network interface 620. For example, network interface 620 may receive incoming communications (such as requests or responses from other devices) in the form of one or more packets (such as Internet Protocol (IP) packets) from network 630, and computer system 600 may store the incoming communications in memory 603 for processing. Computer system 600 may similarly store outgoing communications (such as requests or responses to other devices) in the form of one or more packets in memory 603 and communicated to network 630 from network interface 620. Processor(s) 601 may access these communication packets stored in memory 603 for processing.

Examples of the network interface 620 include, but are not limited to, a network interface card, a modem, and any combination thereof. Examples of a network 630 or network segment 630 include, but are not limited to, a distributed computing system, a cloud computing system, a wide area network (WAN) (e.g., the Internet, an enterprise network), a local area network (LAN) (e.g., a network associated with an office, a building, a campus or other relatively small geographic space), a telephone network, a direct connection between two computing devices, a peer-to-peer network, and any combinations thereof. A network, such as network 630, may employ a wired and/or a wireless mode of communication. In general, any network topology may be used.

Information and data can be displayed through a display 632. Examples of a display 632 include, but are not limited to, a cathode ray tube (CRT), a liquid crystal display (LCD), a thin film transistor liquid crystal display (TFT-LCD), an organic liquid crystal display (OLED) such as a passive-matrix OLED (PMOLED) or active-matrix OLED (AMOLED) display, a plasma display, and any combinations thereof. The display 632 can interface to the processor(s) 601, memory 603, and fixed storage 608, as well as other devices, such as input device(s) 633, via the bus 640. The display 632 is linked to the bus 640 via a video interface 622, and transport of data between the display 632 and the bus 640 can be controlled via the graphics control 621. In some embodiments, the display is a video projector. In some embodiments, the display is a head-mounted display (HMD) such as a VR headset. In further embodiments, suitable VR headsets include, by way of non-limiting examples, HTC Vive, Oculus Rift, Samsung Gear VR, Microsoft HoloLens, Razer OSVR, FOVE VR, Zeiss VR One, Avegant Glyph, Freefly VR headset, and the like. In still further embodiments, the display is a combination of devices such as those disclosed herein.

In addition to a display 632, computer system 600 may include one or more other peripheral output devices 634 including, but not limited to, an audio speaker, a printer, a storage device, and any combinations thereof. Such peripheral output devices may be connected to the bus 640 via an output interface 624. Examples of an output interface 624 include, but are not limited to, a serial port, a parallel connection, a USB port, a FIREWIRE port, a THUNDERBOLT port, and any combinations thereof.

In addition or as an alternative, computer system 600 may provide functionality as a result of logic hardwired or otherwise embodied in a circuit, which may operate in place of or together with software to execute one or more processes or one or more operations of one or more processes described or illustrated herein. Reference to software in this disclosure may encompass logic, and reference to logic may encompass software. Moreover, reference to a computer-readable medium may encompass a circuit (such as an IC) storing software for execution, a circuit embodying logic for execution, or both, where appropriate. The present disclosure encompasses any suitable combination of hardware, software, or both.

The various illustrative logical blocks, modules, circuits, and algorithm operations described in connection with the embodiments disclosed herein may be implemented as electronic hardware, computer software, or combinations of both. To clearly illustrate this interchangeability of hardware and software, various illustrative components, blocks, modules, circuits, and operations have been described above generally in terms of their functionality.

The various illustrative logical blocks, modules, and circuits described in connection with the embodiments disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

The operations of a method or algorithm described in connection with the embodiments disclosed herein may be embodied directly in hardware, in a software module executed by one or more processor(s), or in a combination of the two. A software module may reside in RAM memory, flash memory, ROM memory, EPROM memory, EEPROM memory, registers, hard disk, a removable disk, a CD-ROM, or any other form of storage medium. An exemplary storage medium is coupled to the processor such the processor can read information from, and write information to, the storage medium. In the alternative, the storage medium may be integral to the processor. The processor and the storage medium may reside in an ASIC. The ASIC may reside in a user terminal. In the alternative, the processor and the storage medium may reside as discrete components in a user terminal.

In accordance with the description herein, suitable computing devices include, by way of non-limiting examples, cloud computing platforms, distributed computing platforms, server clusters, server computers, desktop computers, laptop computers, notebook computers, sub-notebook computers, netbook computers, and netpad computers.

In some embodiments, the computing device includes an operating system configured to perform executable instructions. The operating system is, for example, software, including programs and data, which manages the device's hardware and provides services for execution of applications. Various suitable server operating systems include, by way of non-limiting examples, FreeBSD, OpenBSD, NetBSD®, Linux, Apple® Mac OS X Server®, Oracle® Solaris®, Windows Server®, and Novell® NetWare®. Various suitable personal computer operating systems include, by way of non-limiting examples, Microsoft® Windows®, Apple® Mac OS X®, UNIX®, and UNIX-like operating systems such as GNU/Linux®. In some embodiments, the operating system is provided by cloud computing. Various suitable mobile smartphone operating systems include, by way of non-limiting examples, Nokia® Symbian® OS, Apple® iOS®, Research in Motion® BlackBerry OS®, Google® Android®, Microsoft® Windows Phone® OS, Microsoft® Windows Mobile® OS, Linux®, and Palm® WebOS®

### Non-Transitory Computer Readable Storage Medium

In some embodiments, the platforms, systems, media, and methods disclosed herein include one or more non-transitory computer readable storage media encoded with a program including instructions executable by the operating system of an optionally networked computing device. In further embodiments, a computer readable storage medium is a tangible component of a computing device. In still further embodiments, a computer readable storage medium is optionally removable from a computing device. In some embodiments, a computer readable storage medium includes, by way of non-limiting examples, CD-ROMs, DVDs, flash memory devices, solid state memory, magnetic disk drives, magnetic tape drives, optical disk drives, distributed computing systems including cloud computing systems and services, and the like. In some cases, the program and instructions are permanently, substantially permanently, semi-permanently, or non-transitorily encoded on the media.

### Computer Programs

In some embodiments, the platforms, systems, media, and methods disclosed herein include at least one computer program, or use of the same. A computer program includes a sequence of instructions, executable by one or more processor(s) of the computing device's CPU, written to perform a specified task. Computer readable instructions may be implemented as program modules, such as functions, objects, Application Programming Interfaces (APIs), computing data structures, and the like, which perform particular tasks or implement particular abstract data types. A computer program may be written in various versions of various languages.

The functionality of the computer readable instructions may be combined or distributed as desired in various environments. In some embodiments, a computer program comprises one sequence of instructions. In some embodiments, a computer program comprises a plurality of sequences of instructions. In some embodiments, a computer program is provided from one location. In other embodiments, a computer program is provided from a plurality of locations. In various embodiments, a computer program includes one or more software modules. In various embodiments, a computer program includes, in part or in whole, one or more web applications, one or more mobile applications, one or more standalone applications, one or more web browser plug-ins, extensions, add-ins, or add-ons, or combinations thereof.

### Software Modules

In some embodiments, the platforms, systems, media, and methods disclosed herein include software, server, and/or database modules, or use of the same. In view of the disclosure provided herein, software modules are created by various techniques using various machines, software, and languages. The software modules disclosed herein are implemented in a multitude of ways. In various embodiments, a software module comprises a file, a section of code, a programming object, a programming structure, a distributed computing resource, a cloud computing resource, or combinations thereof. In further various embodiments, a software module comprises a plurality of files, a plurality of sections of code, a plurality of programming objects, a plurality of programming structures, a plurality of distributed computing resources, a plurality of cloud computing resources, or combinations thereof. In various embodiments, the one or more software modules comprise, by way of non-limiting examples, a web application, a mobile application, a standalone application, and a distributed or cloud computing application. In some embodiments, software modules are in one computer program or application. In other embodiments, software modules are in more than one computer program or application. In some embodiments, software modules are hosted on one machine. In other embodiments, software modules are hosted on more than one machine. In further embodiments, software modules are hosted on a distributed computing platform such as a cloud computing platform. In some embodiments, software modules are hosted on one or more machines in one location. In other embodiments, software modules are hosted on one or more machines in more than one location.

### DATABASES

In some embodiments, the platforms, systems, media, and methods disclosed herein include one or more databases, or use of the same. Various databases are suitable for storage and retrieval of information, for example customer incident data. In various embodiments, suitable databases include, by way of non-limiting examples, relational databases, non-relational databases, object-oriented databases, object databases, entity-relationship model databases, associative databases, XML databases, document-oriented databases, and graph databases. Further non-limiting examples include SQL, PostgreSQL, MySQL, Oracle, DB2, Sybase, and MongoDB. In some embodiments, a database is Internet-based. In further embodiments, a database is web-based. In still further embodiments, a database is cloud computing-based. In a particular embodiment, a database is a distributed database. In other embodiments, a database is based at least in part on one or more local computer storage devices.

While preferred embodiments of the present invention have been shown and described herein, it will be obvious to those skilled in the art that such embodiments are provided by way of example only. It is not intended that the invention be limited by the specific examples provided within the specification. While the invention has been described with reference to the aforementioned specification, the descriptions and illustrations of the embodiments herein are not meant to be construed in a limiting sense. Numerous variations, changes, and substitutions will now occur to those skilled in the art without departing from the invention. Furthermore, it shall be understood that all aspects of the invention are not limited to the specific depictions, configurations or relative proportions set forth herein which depend upon a variety of conditions and variables. It should be understood that various alternatives to the embodiments of the invention described herein may be employed in practicing the invention. It is therefore contemplated that the invention shall also cover any such alternatives, modifications, variations or equivalents. It is intended that the following claims define the scope of the invention and that methods and structures within the scope of these claims and their equivalents be covered thereby.

What is claimed is:

1. A system for dynamic thermal management of a computing unit, the system comprising:
a) a Trusted Control/Compute Unit (TCU) chipset comprising a Baseboard Management Controller (BMC) and one or more processors, the BMC configured to collect real-time data related to one or more hardware components of the computing unit, wherein the real-time data comprises at least central processing unit (CPU) data or memory usage data indicative of an incoming workload of the computing unit; and
b) a deep reinforcement learning (DRL) model implemented by the one or more processors of the TCU chipset, wherein the DRL model is configured to:
i. receive the real-time data from the BMC as input; and
ii. output a command for adjusting an operation parameter of a cooling system for the computing unit.

2. The system of claim 1, wherein the one or more processors of the TCU chipset comprise one or more programmable artificial intelligence (AI) engines configured to accelerate processing of the DRL model.

3. The system of claim 1, wherein the TCU chipset further comprises one or more of: a secure Network Interface Card (secure-NIC), a hardware Root of Trust (HROT), or a Trusted Platform Module (TPM), or any combination thereof.

4. The system of claim 1, wherein the real-time data indicative of the incoming workload of the computing unit further comprises one or more of: amount of queries, CPU usage, memory usage, disk input and output (disk I/O) operations, network traffic, server performance counters, or request rates, or any combination thereof.

5. The system of claim 1, wherein the real-time data further comprises real-time temperature data relating to temperature of the one or more hardware components of the computing unit.

6. The system of claim 5, wherein the DRL model is further configured to generate a cooling plan for the computing unit based at least in part on the real-time temperature data and the real-time data indicative of the incoming workload.

7. The system of claim 6, wherein the cooling plan is generated based at least in part on determining a disparity between the real-time temperature data of the one or more hardware components of the computing unit and a predetermined target temperature of the respective one or more hardware components, and determining a temperature differential associated with the disparity for each of the one or more hardware components.

8. The system of claim 1, wherein the DRL model is further configured to predict an anticipated incoming workload of the computing unit based at least in part on the real-time data and to predict an anticipated cooling requirement of the one or more hardware components of the computing unit based at least in part on the predicted anticipated incoming workload.

9. The system of claim 1, wherein the DRL model is further configured to assess functionality of one or more cooling elements of the cooling system.

10. The system of claim 1, wherein the operation parameter of the cooling system comprises one or more of: cooling element speed, cooling element power, cooling element orientation, cooling element flow rate, cooling element flow volume, or cooling element flow direction, or any combination thereof.

11. The system of claim 1, wherein the computing unit, the cooling system, or both, comprise one or more sensors, and wherein the TCU chipset is further configured to retrieve data from the one or more sensors, the one or more sensors comprising one or more of: a temperature sensor, a network traffic sensor, an energy consumption sensor, or an operational sensor, or any combination thereof.

12. The system of claim 6, wherein the BMC comprises a graphical user interface (GUI) configured to display the cooling plan to a user and to receive user modifications to the cooling plan, and wherein the one or more processors are further configured to modify the command for adjusting the operation parameter of the cooling system based at least in part on the user modifications.

13. The system of claim 1, wherein the DRL model is further configured to generate an energy efficiency score of the cooling system based at least in part on energy consumption of the cooling system and energy consumption of the computing unit, and to generate a modified cooling plan based at least in part on the energy efficiency score.

14. A method for dynamic thermal management of a computing unit, the method comprising:
a) collecting, by a Baseboard Management Controller (BMC) integrated into a Trusted Control/Compute Unit (TCU) chipset, real-time data related to one or more hardware components of the computing unit, the real-time data comprising at least central processing unit (CPU) data or memory usage data indicative of an incoming workload of the computing unit;
b) receiving, by a deep reinforcement learning (DRL) model implemented by one or more processors of the TCU chipset, the real-time data from the BMC as input; and
c) outputting, by the DRL model, a command for adjusting an operation parameter of a cooling system for the computing unit.

15. The method of claim 14, wherein the one or more processors of the TCU chipset comprise one or more programmable artificial intelligence (AI) engines, and wherein the method further comprises accelerating, by the one or more programmable AI engines, processing of the DRL model.

16. The method of claim 14, wherein the real-time data further comprises real-time temperature data relating to temperature of the one or more hardware components of the computing unit, and wherein the method further comprises generating, by the DRL model, a cooling plan for the computing unit based at least in part on the real-time temperature data and the real-time data indicative of the incoming workload.

17. The method of claim 14, further comprising predicting, by the DRL model based at least in part on the real-time data, an anticipated incoming workload of the computing unit, and predicting an anticipated cooling requirement of the one or more hardware components of the computing unit based at least in part on the predicted anticipated incoming workload.

18. The method of claim 14, further comprising training the DRL model utilizing feedback data comprising data retrieved from one or more sensors of the computing unit or the cooling system subsequent to adjusting the operation parameter of the cooling system.

19. The method of claim 14, further comprising generating, by the DRL model, an energy efficiency score of the cooling system based at least in part on energy consumption of the cooling system and energy consumption of the computing unit, and generating a modified cooling plan based at least in part on the energy efficiency score.

20. The method of claim 14, further comprising generating a digital twin model configured to simulate cooling plan adjustments using in situ characteristic parameters comprising one or more of: rack positions, airflow patterns, climate conditions, or load patterns, or any combination thereof; and training the DRL model utilizing simulated feedback data from the digital twin model.
